(19) United States
(12) Patent Application Publication
(10) Pub. No.: US 2023/0309161 A1
(43) Pub. Date: Sep. 28, 2023

(54) NR RELAYS METHODS FOR SUPPORTING LATENCY REDUCTION FOR SL RELAYS

(71) Applicant: INTERDIGITAL PATENT HOLDINGS, INC., Wilmington, DE (US)

(72) Inventors: Jaya Rao, Montreal (CA); Martino Freda, Laval (CA); Tuong Hoang, Montreal (CA); Tao Deng, Roslyn, NY (US)

(73) Assignee: INTERDIGITAL PATENT HOLDINGS, INC., Wilmington, DE (US)

(21) Appl. No.: 18/019,595

(22) PCT Filed: Aug. 5, 2021
(86) PCT No.: PCT/US2021/044805

§ 371 Date: Feb. 3, 2023

Related U.S. Application Data
(60) Provisional application No. 63/061,617, filed on Aug. 5, 2020.
(60) Provisional application No. 63/223,279, filed on Jul. 19, 2021.

(51) Int. Cl. H04W 76/14; H04L 5/00

(52) U.S. Cl. CPC H04W 76/14; H04L 5/0048; H04W 88/04

(57) ABSTRACT

System(s), method(s), and device(s) for addressing new radio (NR) sidelink latency and protocols. A relay wireless transmit receive unit (WTRU) may be configured to relay information between a remote WTRU and the network. Certain rules, parameters, thresholds, and/or configurations may be used to control and/or reduce latency. In one example, the remote WTRU may send a message to the relay WTRU indicating parameters for data to be relayed; and the relay WTRU may send a message to the network regarding the same.

### CROSS-REFERENCE TO RELATED APPLICATIONS

This application claims the benefit of U.S. Provisional Application No. 63/061,617 fled Aug. 5, 2020 and U.S. Provisional Application No. 63/233,279 filed Jul. 19, 2021, the contents of which are incorporated herein by reference.

### BACKGROUND

As wireless communication devices become more advanced, more use cases arise and greater efficiencies for those use cases are needed. Specifically, in situations where a first wireless transmit receive unit (WTRU), needs to communicate with a second WTRU or the network, which is out of range, it may be beneficial to be able to relay information using a relay WTRU. How this relay occurs presents a need for techniques that may be novel and/or improve upon known techniques.

### SUMMARY

System(s), method(s), and device(s) for addressing new radio (NR) sidelink latency and protocols. A relay wireless transmit receive unit (WTRU) may be configured to relay information between a remote WTRU and the network. Certain rules, parameters, thresholds, and/or configurations may be used to control and/or reduce latency. In one example, the remote WTRU may send a message to the relay WTRU indicating parameters for data to be relayed; and the relay WTRU may send a message to the network regarding the same.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 1E is a system diagram illustrating an example relay communications system in which one or more disclosed embodiments may be implemented;

FIG. 2 is a diagram of an example user plane radio protocol stack for layer 2 evolved WTRU-to-NW relay (PC5);

FIG. 3 is a diagram of an example control plane radio protocol stack for layer 2 evolved WTRU-to-NW relay (PC5);

FIG. 4 is a diagram of an example process for acquiring a relay grant based on a determined latency;

FIG. 5 is a flow chart of an example process for acquiring a relay grant based on a determined latency; and

FIG. 6 is a flow chart of an example process for managing resources for relaying data.

### DETAILED DESCRIPTION

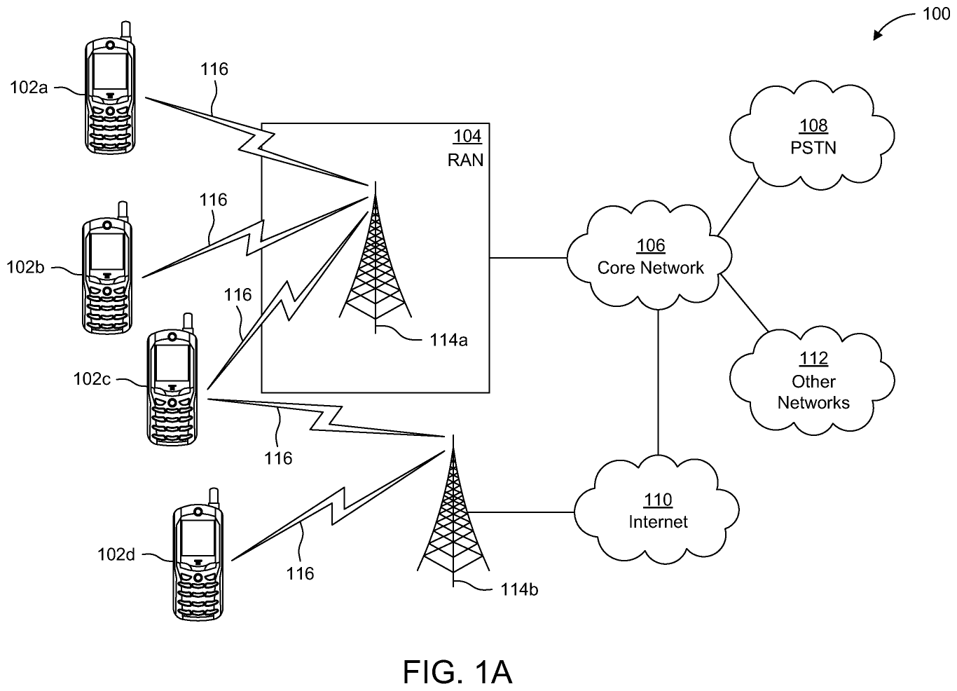

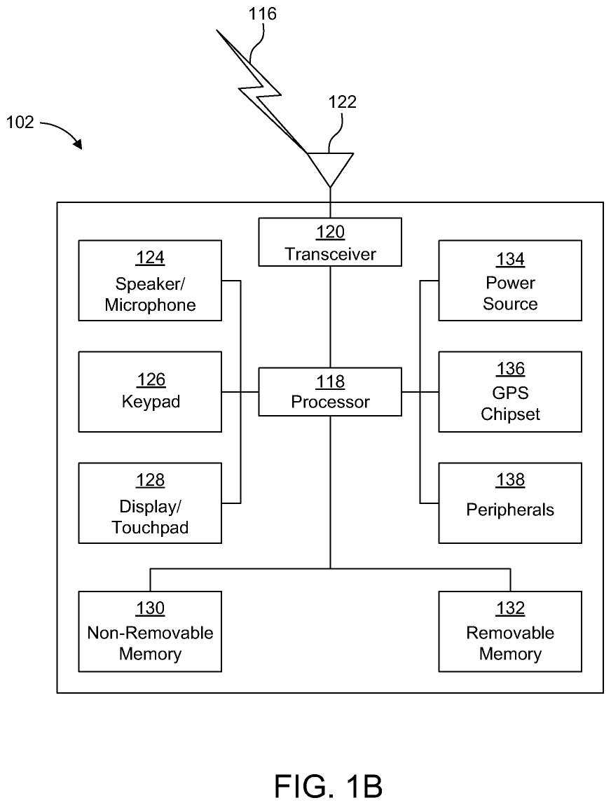

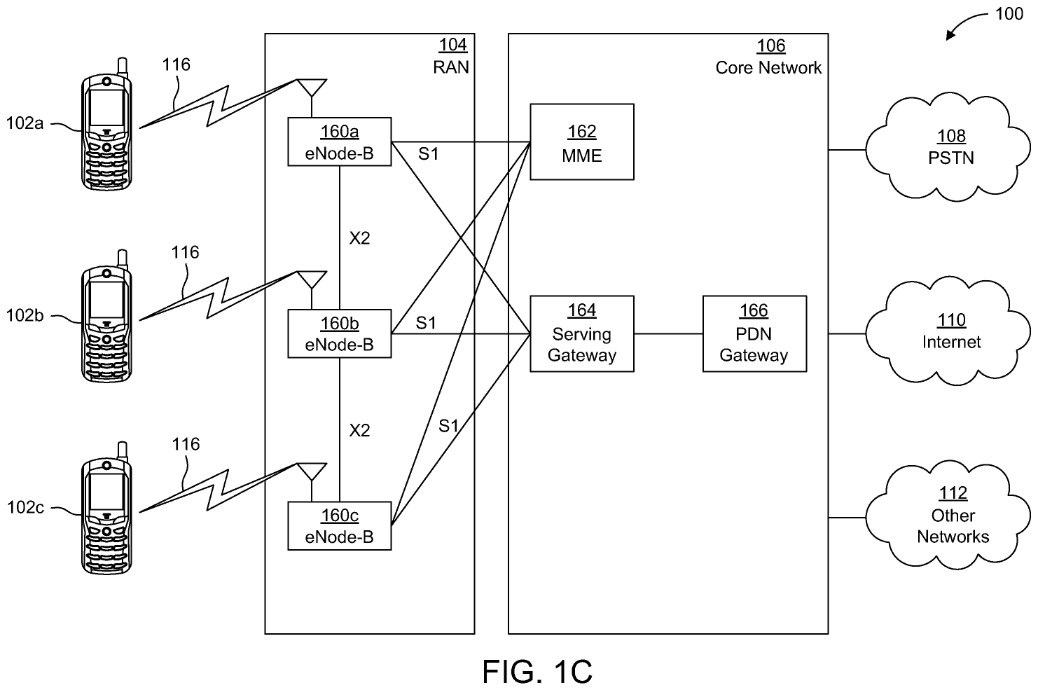

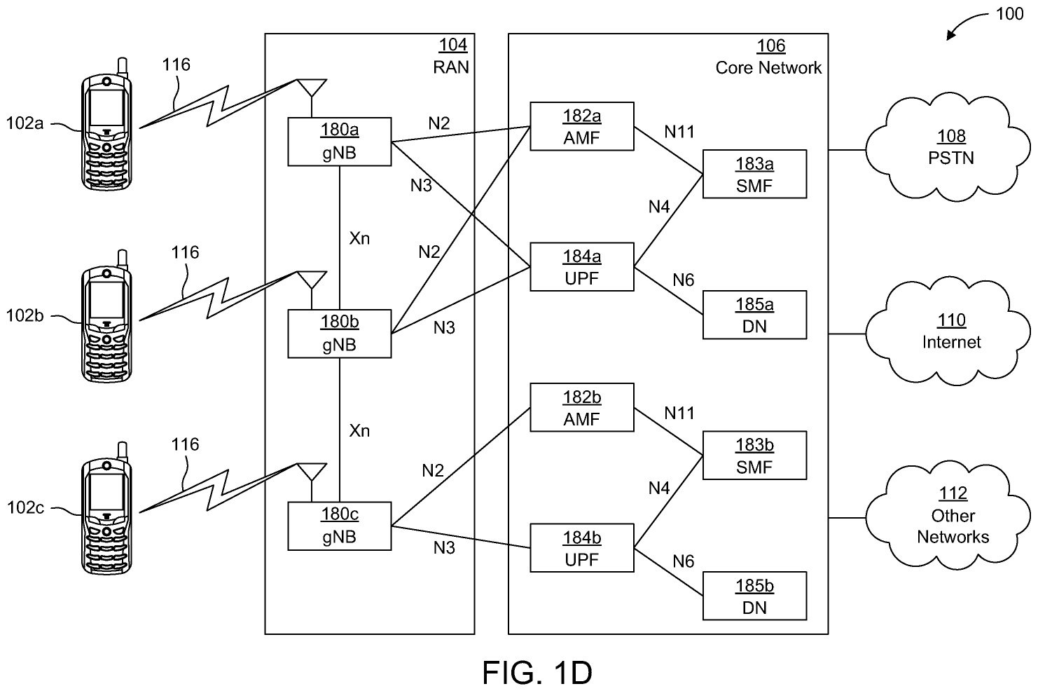

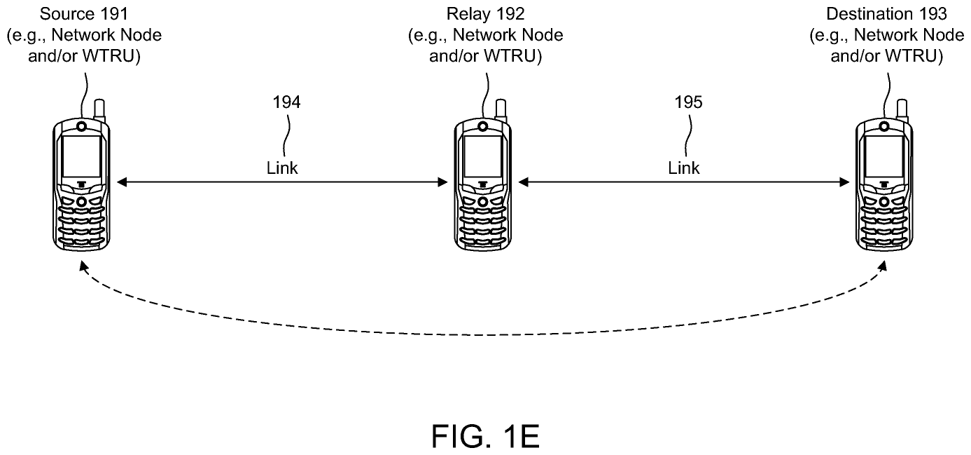

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Generally speaking, disclosed herein there may be reference to communication and/or a connection between a WTRU and the network, where reference to the network is intended to be representative of any entity that is communicating on behalf of the network (NW), such as one or more of: a network node, a base station, a WTRU acting on behalf of the network (e.g., a relay), and/or any functional entity described herein. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the aft interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may Include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the ON 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In one or more embodiments, there may be techniques for the configuration and use of relay WTRUs (e.g., for reducing latency). FIG. 1E a system diagram illustrating an example relay communications system in which one or more disclosed embodiments may be implemented. The example scenario shown in FIG. 1E may implement any of the examples described herein. Generally, for any relay system there are at least three entities involved, a source 191, a relay 192, and a destination 193. Note, that the source 191 may be remote from the destination 193, and in some cases the source or destination may be referred to as a remote entity. The source 191 may communicate with the relay 192 over a first link 194, and the relay 192 may communicate with the destination 193 over a second link 195. Note, while the naming may suggest that the source 191 instigates the communication, the name should not be interpreted as limiting and is for demonstrative purposes only, and communication may be instigated by any entity (e.g., relay 192 and/or destination 193). While not shown, there may be more than one relay 192, which may be represented by relay 192 even though only one entity is shown; further, any description herein may apply to multiple relays, where there would also be links in between each hop between each relay/entity. The multiple relays would facilitate communication between the source 191 and the destination 193. It follows that the links shown are not intended to limit the embodiments described herein to only one connection or one layer of connection for each link, but rather merely to show that communication may occur between the two entities. As discussed herein, one link may be representative of multiple logical links (e.g., SRB, LCH, etc.); as discussed herein, SRB and LCH may be interchangeable. The source, relay, and/or destination may be any type of entity, such as a WTRU, a network node (e.g., base station or other functional entity), and/or other entity described herein. In one example, the source 192 may be a first remote WTRU that may need to communicate with a destination 193. The destination 193 may be a network node or a second remote WTRU. In order to facilitate communication between the source 191 and destination 193, a relay 192 may be used (e.g., to bridge a distance that may be too far to allow for communication, or because such a bridge may offer other advantages, such as better bandwidth, lower latency, added security, etc.). As described herein, the source 191 may referred to as a first remote WTRU, the relay 192 as a relay WTRU, and the destination 193 as a second remote WTRU or a network node. Further, a peer WTRU may signify another WTRU than the one being discussed (e.g., a first remote WTRU may send a signal to a peer WTRU, which may by a relay WTRU, a second remote WTRU, etc.). While FIG. 1E shows a direct communication (e.g., unicast), the entities described also apply to multicast or groupcast messages, where there would be more than one source 191 and/or more than one destination 193.

In view of FIGS. 1A-1E, and the corresponding description of FIGS. 1A-1E, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Generally regarding relay techniques, such as WTRU-to-Network (WTRU-to-NW) relays, there may be certain capabilities required for ensuring that the higher layer QoS requirements (e.g., packet delay bound (PDB)) are satisfied on an end-to-end (E2E) basis when transmitting data from the remote WTRU-to-NW via a relay WTRU. Similarly, in WTRU-to-WTRU relaying scenarios, the relay WTRUs may be required to ensure that the E2E QoS requirements are satisfied when relaying data received from a source WTRU to target WTRU via the relay WTRU.

Unlike legacy relay Nodes and IAB nodes, the relay WTRU as discussed herein may not perform resource scheduling for the associated remote WTRU/source WTRU and control the timing for data transmission in sidelink. The remote WTRU (e.g., in WTRU-to-NW relaying) or source WTRU (e.g., in WTRU-to-WTRU relaying) may operate either in Mode 1 (e.g., sidelink resources are scheduled by network) or in Mode 2 (e.g., sidelink resources are determined autonomously using resource (re)selection procedure).

The relay WTRU may request UL resources for relaying based on the data reception in sidelink. However, without coordination it may be possible that UL resources may be allocated by network either too early (e.g., UL grant provided before data is available) or too late due to the following reasons: the remote WTRU is unaware of the latency at the relay WTRU (e.g., processing delay, half-duplex); and/or, the network may be unaware of the transmission time at remote WTRU and transmission latency over the sidelink (e.g., number of ReTx).

Likewise, in DL the network may not be aware of the transmission latency over the sidelink for transmitting data to remote WTRU(s). In WTRU-to-WTRU relaying, since the source WTRU is unaware of the transmission latency in the second hop between the relay WTRU and target WTRU, it may be possible that performing resource (re)selection (e.g., for relay WTRU operating in Mode 2) or requesting for resources (for relay WTRU operating in Mode 1) after receiving the data from the source WTRU may result in not satisfying the E2E PDB requirement.

As such, there is a needed for various approaches to address these issues regarding a remote WTRU and relay WTRU to ensure resources in sidelink and Uu interfaces are aligned with proper timing offset such that a E2E PDB requirement is satisfied. In one or more embodiments disclosed herein, there are techniques regarding how to fulfil the end-to-end PDB requirement in a WTRU-to-NW relayed path or in WTRU-to-WTRU relayed path when transmitting data from the remote WTRU and relay WTRU will be addressed, along with other related details and techniques. In these one or more embodiments, there will be systems, methods, and devices directed towards the techniques and approaches described herein (e.g., for reducing latency in side link relays, and other purposes).

In one or more embodiments, there may be systems, methods, and/or devices that address NR sidelink situations where there may be WTRU-to-NW relay(s) and/or WTRU to WTRU relay(s) (e.g., based on a PC5 sidelink, or the like). Generally, NR sidelink has focused on supporting V2X related services. Additionally, NR sidelink may support broadcast, groupcast, and unicast communications in both out-of-coverage and in-network coverage scenarios. Accordingly, there is a need for NR sidelink based relaying functionality because it may result in coverage extension and power efficiency improvements.

In WTRU-to-NW coverage extension, Uu coverage reachability may be necessary for WTRUs to reach a server in a PDN network or counterpart WTRU out of proximity (e.g., a predefined area that may be related to the ability of receiving/sending signals). However, current approaches to WTRU-to-NW relay may be limited to EUTRA-based technology, and thus is not applicable to NR-based system, for both NG-RAN and NR-based sidelink communication. Accordingly, new approaches and improvements may be warranted.

In WTRU-to-WTRU coverage extension, current proximity reachability may be limited to single-hop sidelink link, either via EUTRA-based or NR-based sidelink technology. However, these limitations may not be sufficient in a scenario where there is no Uu coverage, considering the limited single-hop sidelink coverage. Accordingly, new approaches and improvements may be warranted.

It follows, then, there is a need for NR sidelink development and approaches in order to support additional use cases, such as enhanced QoS requirements.

In addition to the issues above, disclosed herein are approaches that address one or more of the following: relay (re)selection criterion and procedure(s); relay/remote WTRU authorization; QoS for relaying functionality; service continuity; security of relayed connection; and/or, impact on user plane protocol stack and existing control plane procedures (e.g., connection management of relayed connections). Additionally, there may be approaches for upper layer operations of discovery models/procedures for sidelink relaying (e.g., assuming no new physical layer channel/signals).

As discussed herein, any single-hop scenario described is intended for demonstration purposes only, and not intended to limit the applicability for the techniques and approaches disclosed herein to multi-hop scenarios. All techniques and approaches disclosed herein are intended to apply to single-hop and multi-hop, where applicable.

In some scenarios, relaying via ProSe WTRU-to-NW relays may extend network coverage to an out of coverage WTRU by using PC5 (D2D) between an out of coverage WTRU and a WTRU-to-NW relay. For example, a ProSe WTRU-to-NW relay may provide a generic L3 forwarding function that can relay any type of IP traffic between a remote WTRU and the network (e.g., a network node, base station, etc.). One-to-one and one-to-many sidelink communications may be used between the remote WTRU(s) and the ProSe WTRU-to-NW relay. For both remote WTRU and relay WTRU only one single carrier (e.g., Public Safety ProSe Carrier) operation may be supported (e.g., Uu and PC5 should be the same carrier for relay/remote WTRU). The remote WTRU may be authorized by upper layers and may be in-coverage of the Public Safety ProSe Carrier or out-of-coverage on any supported carriers including Public Safety ProSe Carrier for WTRU-to-NW relay discovery, (re)selection and communication. The ProSe WTRU-to-NW relay may always be in-coverage of EUTRAN.

In some scenarios, there may be a relay selection for WTRU-to-NW relays. Specifically, relay selection/reselection for ProSe WTRU-to-NW relays may be performed based on a combination of a AS layer quality measurements (e.g., RSRP) and upper layer criteria. This is described in more detail herein.

The network (e.g., eNB, gNB, base station, network node, functional entity, other WTRU acting as the network, etc.) may control whether the WTRU can act as a ProSe WTRU-to-NW relay, where: if the network broadcasts any information associated to ProSe WTRU-to-NW relay operation, then the ProSe WTRU-to-NW relay operation may be supported in the cell; and/or, if the ProSe WTRU-to-NW relay is initiated by broadcast signaling, it may perform ProSe WTRU-to-NW relay discovery when in RRC_IDLE. If the ProSe WTRU-to-NW relay is initiated by dedicated signaling, it may perform relay discovery as long as it is in RRC_CONNECTED.

In some cases, the network may provide transmission resources for ProSe WTRU-to-NW relay discovery using broadcast signalling for RRC_IDLE state and dedicated signalling for RRC_CONNECTED state.

In some cases, the network may provide reception resources for ProSe WTRU-to-NW relay discovery using broadcast signalling.

In some cases, the network may provide (e.g., broadcast) a minimum and/or a maximum Uu link quality (e.g., RSRP) threshold(s) that the ProSe WTRU-to-NW relay needs to adhere to before it can initiate a WTRU-to-NW relay discovery procedure. In RRC_IDLE, when the network broadcasts transmission resource pools, the WTRU may use the threshold(s) to autonomously start or stop the WTRU-to-NW relay discovery procedure. In RRC_CONNECTED, the WTRU may use the threshold(s) to determine if it can indicate to the network that it is a relay WTRU and wants to start ProSe WTRU-to-NW relay discovery.

In some cases, where the network does not broadcast transmission resource pools for ProSe-WTRU-to-NW relay discovery, then a WTRU may initiate a request for ProSe-WTRU-to-NW relay discovery resources by dedicated signalling, respecting these broadcasted threshold(s).

A ProSe WTRU-to-NW relay performing sidelink communication for ProSe WTRU-to-NW relay operation may need to be in RRC_CONNECTED. After receiving a layer-2 link establishment request or TMGI monitoring request (e.g., upper layer message) from the remote WTRU, the ProSe WTRU-to-NW relay may indicate to the network that it is a ProSe WTRU-to-NW relay and intends to perform ProSe WTRU-to-NW relay sidelink communication. The network may provide resources for ProSe WTRU-to-NW relay communication.

The remote WTRU may decide when to start monitoring for ProSe WTRU-to-NW relay discovery. The remote WTRU may transmit ProSe WTRU-to-NW relay discovery solicitation messages while in RRC_IDLE or in RRC_CONNECTED depending on the configuration of resources for ProSe WTRU-to-NW relay discovery. The network may broadcast a threshold, which is used by the remote WTRU to determine if it can transmit ProSe WTRU-to-NW relay discovery solicitation messages, to connect or communicate with ProSe WTRU-to-NW relay WTRU. The RRC_CONNECTED remote WTRU may use the broadcasted threshold to determine if it can indicate to the network that it is a remote WTRU and wants to participate in ProSe WTRU-to-NW relay discovery and/or communication. The network may provide, transmission resources using broadcast or dedicated signalling and reception resources using broadcast signaling for ProSe WTRU-to-NW relay Operation. The remote WTRU may stop using ProSe WTRU-to-NW relay discovery and communication resources when RSRP goes above the broadcasted threshold.

In some cases, the exact time of traffic switching from Uu to PC5 or vice versa may be up to higher layer.

The remote WTRU may perform radio measurements at a PC5 interface and use them for ProSe WTRU-to-NW relay selection and reselection along with higher layer criterion. A ProSe WTRU-to-NW relay may be considered suitable in terms of radio criteria if the PC5 link quality exceeds a configured threshold (e.g., pre-configured or provided by the network). The remote WTRU may select the ProSe WTRU-to-NW relay, which satisfies higher layer criterion and has best PC5 link quality among all suitable ProSe WTRU-to-NW relays.

The remote WTRU may trigger ProSe WTRU-to-NW relay reselection when: PC5 signal strength of current ProSe WTRU-to-NW relay is below configured signal strength threshold; and/or, it receives a layer-2 link release message (e.g., upper layer message) from ProSe WTRU-to-NW relay.

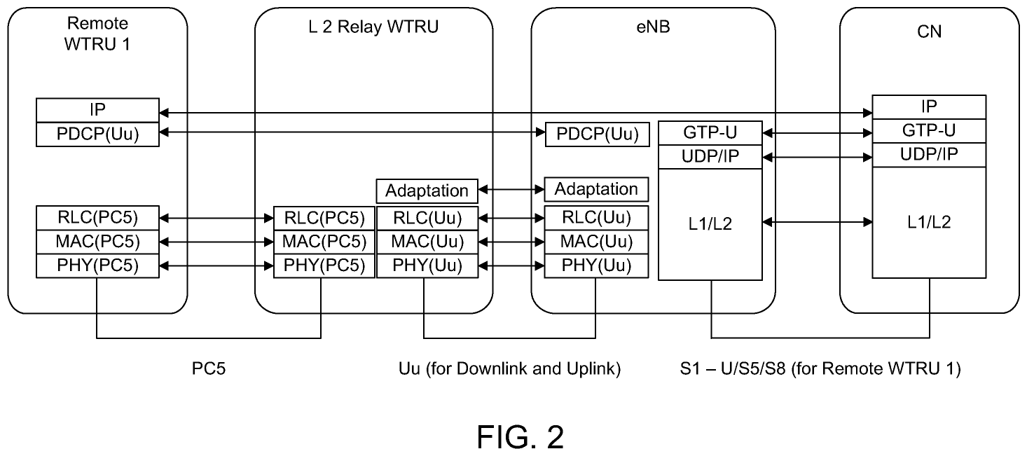

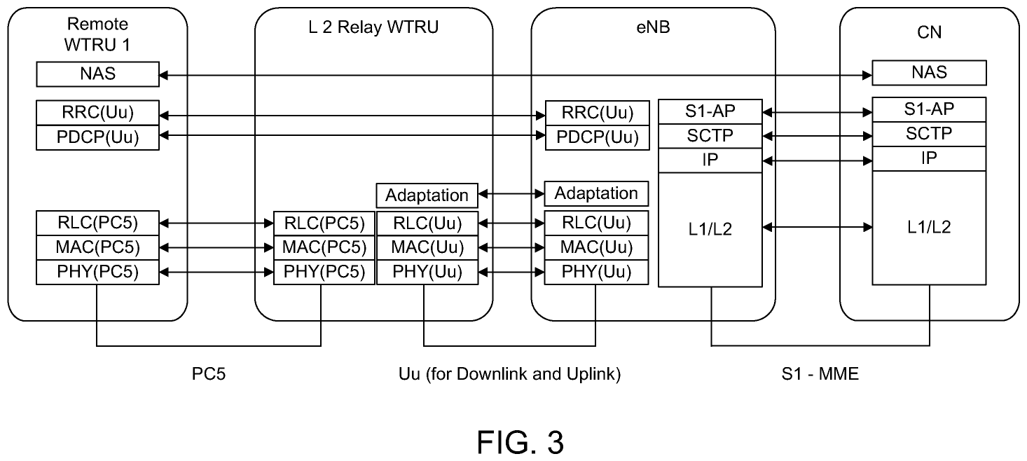

In some specific use cases, there may be WTRU-to-NW relays that use a L2 based approach (e.g., for wearable devices, and/or WTRUs). Unlike ProSe WTRU-to-NW relays, which use a L3 (IP layer) relaying approach, the WTRU-to-NW relays for wearables may use a L2 relay based on protocol stacks, such as those shown in FIG. 2 and FIG. 3. FIG. 2 is a diagram of an example user plane radio protocol stack for layer 2 evolved WTRU-to-NW relay (PC5); and FIG. 3 is a diagram of an example control plane radio protocol stack for layer 2 evolved WTRU-to-NW relay (PC5). For NR, the protocol stack in examples FIG. 2 or FIG. 3 may also include an SDAP layer present at the remote WTRU and/or the gNB (e.g., above PDCP).

In some scenarios, there may be a connection establishment process for unicast links in NR V2X. In relay solutions for LTE, this may be based on a one-to-one communication link established at upper layers (e.g., ProSe layer) between two WTRUs (e.g., the remote WTRU and WTRU-to-NW relay). Such a connection may be transparent to the AS layer and connection management signaling, and procedures may be performed at the upper layers and carried by AS layer data channels. The AS layer may be, therefore, unaware of such a one-to-one connection.

In NR V2X, the AS layer may support the approach of a unicast link between two WTRUs. Such a unicast link may be initiated by upper layers (e.g., as in the ProSe one-to-one connection). However, the AS layer may be informed of the presence of such a unicast link, and any data that may be transmitted in a unicast fashion between the peer WTRUs. With such knowledge, the AS layer may support HARQ feedback, CQI feedback, power control schemes which are specific to unicast, and/or other related features/functions.

A unicast link at the AS layer may be supported via a PC5-RRC connection. The PC5-RRC connection may be a logical connection between a pair of a Source Layer-2 ID and a Destination Layer-2 ID in the AS. One PC5-RRC connection may correspond to one PC5 unicast link. The PC5-RRC signalling may be initiated after its corresponding PC5 unicast link establishment. The PC5-RRC connection and the corresponding sidelink SRBs and sidelink data radio bearers (SLRBs) may be released when the PC5 unicast link is released as indicated by upper layers.

For each PC5-RRC connection of unicast, one sidelink SRB may be used to transmit the PC5-S messages before the PC5-S security has been established. One sidelink SRB may be used to transmit the PC5-S messages to establish the PC5-S security. One sidelink SRB may be used to transmit the PC5-S messages after the PC5-S security has been established, which may be protected. One sidelink SRB may be used to transmit the PC5-RRC signalling, which may be protected and only sent after the PC5-S security has been established.

The PC5-RRC signaling may include a sidelink configuration message (RRCReconfigurationSidelink) where a first WTRU configures the RX-related parameters of each SLRB in the second WTRU. Such a reconfiguration message may configure the parameters of each protocol in the L2 stack (e.g., service data adaption protocol (SDAP), packet data convergence protocol (PDCP), etc.). The second WTRU may confirm or reject such configuration, depending on whether it can support the configuration suggested by the first WTRU.

In some scenarios, there may be buffer status reporting (BSR) in Integrated Access and Backhaul (IAB), where IAB may support pre-emptive BSR status reporting. The BSR procedure may be used to provide a serving base station (e.g., gNB) with information about UL data volume in the MAC entity. In the case of IAB, it may be additionally used by an IAB mobile terminal (IAB-MT) to provide its parent IAB distributed unit (IAB-DU) with the information about the amount of the data expected to arrive at the MT of the IAB node from its child node(s) and/or WTRU(s) connected to it. This BSR may be referred to as pre-emptive BSR.

For BSR other than pre-emptive BSR, RRC may configure the following parameters to control the BSR: periodicBSR-Timer; retxBSR-Timer; logicalChannelSR-DelayTimerApplied; logicalChannelSR-DelayTimer; logicalChannelSR-Mask; and/or, logicalChannelGroup.

Each logical channel may be allocated to an LCG using the logicalChannelGroup. The maximum number of LCGs may be eight.

The MAC entity may determine the amount of UL data available for a logical channel according to the data volume calculation procedure.

A BSR other than pre-emptive BSR may be triggered if any of the following events occur: UL data becomes available to the MAC entity, where the UL data is for a logical channel that belongs to an LCG, and either this UL data belongs to a logical channel with higher priority than the priority of any logical channel containing available UL data that belongs to any LCG, or none of the logical channels which belong to an LCG contains any available UL data, in which case the BSR may be referred below to as ‘Regular BSR’; UL resources are allocated and number of padding bits is equal to or larger than the size of the Buffer Status Report MAC CE plus its subheader, in which case the BSR may be referred to as ‘Padding BSR’; retxBSR-Timer expires, and at least one of the logical channels which belong to an LCG contains UL data, in which case the BSR may be referred to as ‘Regular BSR’; and/or, periodicBSR-Timer expires, in which case the BSR may be referred to as ‘Periodic BSR’.

Note, when Regular BSR triggering events occur for multiple logical channels simultaneously, each logical channel may trigger one separate Regular BSR.

If configured, pre-emptive BSR may be triggered for the specific case of an IAB-MT if any of the following events occur: UL grant is provided to child IAB node or WTRU; and/or, BSR is received from child IAB node or WTRU.

In some situations, a remote WTRU may send an assistance indication for relaying with packet delay bound(s) (PDB) requirement(s) (e.g., QoS or Latency requirements) to a relay WTRU in sidelink. Specifically, a remote WTRU (e.g., configured with an indirect relaying path to the network/other WTRU via a relay WTRU) may send a remote WTRU assistance indication to a relay WTRU. The remote WTRU assistance indication message may indicate the availability of data for transmission at the remote WTRU and trigger the relay WTRU to obtain UL/SL resources for relaying the data to the dentation upon reception of the data from the remote WTRU. The remote WTRU may send the indication message prior to sending the data to the relay WTRU for minimizing the latency at the relay WTRU associated with a resource scheduling procedure. For example, upon reception at the relay WTRU of the indication from the remote WTRU, the relay WTRU may send SR and/or BSR to the network and receive an UL grant for transmitting the data to be relayed. The relay WTRU may transition to an RRC connected state upon reception of the indication from the remote WTRU and subsequently perform a resource scheduling procedure, if the relay WTRU is initially in RRC idle state, for example.

Regarding the contents of the remote WTRU assistance indication, the remote WTRU may include a combination of one or more of the following types information in the remote WTRU assistance indication sent to the relay WTRU: buffer size of data volume at the remote WTRU; QoS-related parameter(s); PDB related information; timing information for relaying data; index of a sidelink/HARQ process or configured grant; and/or, cell ID of the network node (e.g., the network node may be a gNB in the case of the remote WTRU is in coverage of a gNB).

Regarding the buffer size or data volume at the remote WTRU, for example, the remote WTRU may indicate the data volume in one or more LCHs at the remote WTRU, possibly associated with relayed data and/or signaling radio bearers (DRBs and/or SRBs), which span between the remote WTRU to the relay WTRU in the NR SL interface and between relay WTRU and network in the NR Uu interface. In this case, for each LCH with data PDU in buffer the remote WTRU my indicate the data volume (e.g., bit size) along with the identifier (ID) of the LCH, ID of LCG, and/or ID of the data and/or signaling radio bearer.

Regarding QoS-related parameter(s), for example, the remote WTRU may indicate the priority associated with the LCHs that have data in the buffer for transmission via a relay WTRU. The priority may be either indicated explicitly in the indication message or implicitly by indicating the ID of the LCH or ID of the LCG associated with the LCH. The remote WTRU may then identify the priority based on a mapping between the ID of LCH/LCG and the priority configured at the relay WTRU, for example.

Regarding Packet Delay Bound (PDB) related information, for example, this may comprise of the PDB associated with any one or multiple parts of the end-to-end path. The PDB may represent the allocated or remaining delay budget over the sidelink portion of the relayed path. The PDB may represent the total allocated or remaining delay budget over the entire relayed path (e.g., to the network or destination WTRU). For example, the remote WTRU may indicate the expected remaining time available for the relay WTRU to perform resource scheduling and data transmission in UL. The expected remaining time may be determined by subtracting the expected delay due to (re)transmission on sidelink from the E2E PDB, for example.

Regarding timing information for relaying data, for example, the remote WTRU may indicate the expected latency or time duration for the data to be reliably received at the relay WTRU or expected to be transmitted by the remote WTRU. The expected time duration may be determined based on the sidelink channel conditions/quality (e.g., CBR, CR, SL-CSI) and/or the expected number of HARQ retransmissions to be performed on sidelink, for example. The expected time duration may also be determined based on results of resource selection by the remote WTRU. The expected time duration may also be determined based on scheduling information (e.g., in DCI) received from the network.

Regarding the index of a sidelink/HARQ process or configured grant, for example, the assistance indication sent to the relay WTRU may represent a specific (e.g., possibly periodic) sidelink process, or an instance of a sidelink configured grant, and the assistance information may indicate the timing/offset and/or periodicity of the sidelink configured grant.

In one example, the remote WTRU assistance indication sent to the relay WTRU, prior to sending the data in sidelink, may indicate only the availability of data at the remote WTRU to be transmitted in UL. Based on the reception of the indication the relay WTRU may determine the timing for sending a relay WTRU assistance indication (e.g., SR, BSR, pre-emptive BSR, or RRC message such as UEAssistanceInformation) to the network to request for UL resources, considering the expected delay on sidelink for receiving the data from the remote WTRU.

In another example, the remote WTRU may include in the remote WTRU assistance indication, in addition to the information on data availability, the timing information for triggering an UL resource request message (e.g., remote WTRU assistance indication) at the relay WTRU. For this example, the remote WTRU may send in the remote WTRU assistance indication with the expected latency or time duration for the data to be reliably received at the relay WTRU. The remote WTRU may determine the timing information to be included in the remote WTRU assistance indication based on one or more of the following: delay of the sidelink; indication of delay from the relay WTRU; and/or, indication of QoS status from a higher layer.

For the delay of the sidelink, the remote WTRU may determine the delay on sidelink as a function of the expected number of HARQ retransmissions and/or the sidelink channel conditions/quality. The sidelink channel condition (e.g., SL-RSRP, CBR) may be determined either based on CSI feedback provided by the relay WTRU or sensing at the remote WTRU, for example. The delay on sidelink may also be determined based on sensing results and/or the selected resources for transmission by the remote WTRU.

For the indication of delay from the relay WTRU, the remote WTRU may be configured to receive either periodic or event-triggered indication from the relay WTRU regarding the status of the transmission latency for one or more LCHs on the Uu interface to the network associated with the remote WTRU. Alternative, the indication sent by the relay WTRU may be a flow control message that indicates either the suspend/resume status of data transmission on sidelink or the rate at which data is to be transmitted by the remote WTRU. In this case, the status of the latency on Uu interface or the flow control message may be used by the remote WTRU to estimate the timing information to be included in a remote WTRU assistance indication, for example.

For the indication of QoS status from a higher layer (e.g., of the remote WTRU), the remote WTRU may determine the timing information based on the monitoring of the end-to-end (e.g., higher layer) QoS status between the remote WTRU and network. The higher layer QoS status related to the PDB, for example, may be provided to the remote WTRU in a NAS message by the network either periodically or based on an event trigger (e.g., when PDB exceeds certain threshold value). In this case, the QoS status may be used by the remote WTRU to either reduce the time duration indicated to the relay WTRU if the end-to-end PDB increases above a threshold value or to increase the time duration if the end-to-end PDB reduces below another threshold value.

The remote WTRU may send the indication to the relay WTRU in one or more of the following: SCI; SL MAC CE; PC5-RRC; and/or, data payload.

For the case of the SCI, for example, the indication may be sent in PSCCH stage 1 SCI or in stage 2 SCI. The SCI may be sent either in a standalone transmission comprising of only the stage 1 and/or stage 2 SCI or along with a PSSCH data transmission. The indication in SCI may be used for triggering the relay WTRU assistance indication (e.g., SR, BSR, pre-emptive BSR) at the relay WTRU for data with one or more fixed data volumes/sizes, for example.

For the case of the SL MAC CE, for example, the indication sent in a SL MAC CE may include bitmap corresponding to one or more of the following information elements: data volume/buffer size of the egress LCH configured with the relayed radio bearer, timing information for triggering relay WTRU assistance indication, remaining PDB, and/or the like. The one or more different information elements may be sent in either a single SL MAC CE or in a different SL MAC CEs. The information elements within the indication, when sent in one or more MAC CEs, may be identified with the new LCID(s) that are included in the SL MAC CE header.

For the case of the PC5-RRC, the indication may be sent as a PC5-RRC message to the relay WTRU in a configured SL-SRB, containing the information related to data volume and/or timing information, for example.

For the case of the data payload, the indication may be sent to the relay WTRU in a data payload. The (small) data payload may be either appended to an ongoing sidelink data transmission or may use a new sidelink data transmission, for example.

Resources for sending a remote WTRU assistance indication in sidelink may be determined using one or more techniques, one or more of which may be based on one or more of the following cases: resources configured for operation in Mode 2; random selection for configured resource pool(s); semi-persistent or periodic resources; scheduling request; and/or dedicated resource in sidelink.

For the case of resources configured for operation in Mode 2, the remote WTRU may select the resources for sending the indication based on sensing in the one or more resource pool(s) configured for operation in Mode 2 operation. In this case, if the WTRU is initially operating in Mode 1, the WTRU may either transition to operating in Mode 2 or simultaneously operate in Mode 1 and Mode 2 when selecting the resources, for example. Likewise, a WTRU operating in Mode 2 may either use the resources selected for a different sidelink data transmission process or trigger resource reselection for selecting resources for sending the indication. To ensure that the relay WTRU is able to receive the indication sent using the resources from resource pool(s) configured for operation in Mode 2, the remote WTRU may perform resource selection based on the awareness of the timing related to the relay WTRU reception and the resource pool(s) monitored by the relay WTRU for reception, for example. The awareness of the relay WTRU behavior associated with reception may be acquired by the remote WTRU during link/SLRB establishment and/or (re)configuration.

For the case of random selection from a configured resource pool(s), the remote WTRU may determine the resources by selecting the resources randomly from one or more configured resources pool(s). The resource pool used to perform random selection may be associated with Mode 2 operation, for example. The remote WTRU may perform random selection from a subset or a bandwidth-part comprising of a limited number of subchannels/PRBs within the resource pool, where the subset/bandwidth-part may be known to both the remote WTRU and relay WTRU and configured (e.g., by the network or WTRU) for the transmission of the indication. In this case, the relay WTRU may identify the indication sent by the remote WTRU based on the reception of the indication using the resources corresponding to the configured subset/bandwidth-part in the resource pool.

For the case of semi-persistent or periodic resources, the remote WTRU may use semi-persistent or periodic resources provided in configured grant(s) for sending the indication to the relay WTRU. The configured grant may be provided by the network for a remote WTRU operating in Mode 1 based on the WTRU assistance information provided by the remote WTRU to the network, which may contain the payload size of the remote WTRU assistance indication message and periodicity information, for example. A remote WTRU operating in Mode 2 may perform resource selection to reserve periodic resources for sending the indication to the relay WTRU. As an example, the remote WTRU may use either the periodic resources dedicated for the transmission of only the indication message or use the periodic resources obtained for transmission of data to the relay WTRU if resources are available to accommodate the indication. Based on the received indication from the remote WTRU using periodic resources in a configured grant, the relay WTRU may also be triggered to send a WTRU assistance information message in RRC to the network for requesting and/or aligning the periodic resources in the configured grant on the Uu interface with the periodic resources used by the remote WTRU in the sidelink. In this case, the relay WTRU may indicate in the WTRU assistance information the offset value associated with the delay at the relay WTRU (e.g., due to processing) when aligning the periodic resources (e.g., configured grants) in the sidelink and Uu interfaces. In an example, a relay WTRU may perform any of the following upon reception of the remote WTRU assistance information: determine whether there is a need to change the periodicity and/or grant size and/or timing of the current UL configured grant based on the periodicity/size/timing information received in the remote WTRU assistance information; upon determination of the need to change the periodicity/size/timing of the current UL configured grant, the WTRU may determine a new preferred periodicity/grant size/offset; and/or, transmit the WTRU assistance information to the network to request re-configuration of the UL configured grant.

For the case of a scheduling request (SR), the remote WTRU operating in Mode 1 may trigger a SR when data for relaying arrives in the buffer to request for resources for sending the indication. The SR triggered may be either a regular SR used for requesting resources for sending a BSR or a dedicated/special SR used only for requesting resources for sending the indication in sidelink, for example. In the case of the regular SR, the triggering conditions applied by the remote WTRU may correspond to arrival of data for relaying in buffer and unavailability of resources for sending the indication in sidelink, for example. In the case of a dedicated SR, the remote WTRU may use resources from a configured resource pool or bandwidth-part for sending the SR, which may be restricted only for certain types of messages including the remote WTRU assistance indication, for example.

For the case of dedicated resources in sidelink, the remote WTRU may use one or more resources from a specific area within a configured resource pool or bandwidth-part which may be dedicated for sending the indication. In another example, the dedicated resources may be accessible using a dedicated PHY channel such as PSFCH, PSCCH or PSSCH. The identifier for the indication may be either indicated explicitly or implicitly based on the usage of the dedicated resources which are known to both remote WTRU and relay WTRU, for example. In this case, the relay WTRU may be able to identify the received indication based on filtering of the resources at the known area within the configured resource pool/bandwidth-part. The configured resource pool which the remote WTRU may be an exceptional pool (pre)configured in the remote WTRU, for example.

The remote WTRU assistance indication may be sent to the relay WTRU due to one or more triggering conditions: data arrival in buffer; timer; indication from relay WTRU; indication from a higher layer (e.g., NAS); value of, or change in sidelink conditions/quality; change in any periodicity, offset, required grant size of a periodic transmission of data at the remote WTRU; one or more criteria associated with timing information and/or PDB of the data to be transmitted; and/or, reception of HARQ feedback.

Regarding the trigger condition of data arrival in buffer, the remote WTRU may generate and send the indication when data from higher layers arrive in an LCH configured to the relayed radio bearer in sidelink. In the case when the remote WTRU is configured with multiple LCHs to the relayed radio bearer, the indication may be triggered when data arrives in any of the LCHs or when data arrives in a LCH that may have higher priority than another lower priority LCH which may have previously triggered the indication. For minimizing the triggering events related to generating and sending the indication, the relay WTRU may be configured with one or more criteria where the indication may be triggered and sent only for certain LCHs (e.g., URLLC) for example, with a priority that is greater than or equal to a configured priority threshold, or for LCH(s) that are configured to allow triggering such an indication.

Regarding the trigger condition of a timer, the indication may be triggered at the remote WTRU based on a timer, possibly associated with processing delay at the relay WTRU. The timer may be used to ensure that the indication is sent to coincide with the time for triggering the relay WTRU assistance indication (e.g., SR, pre-emptive BSR) at the relay WTRU. In this case, the remote WTRU may set a timer when data arrives in a LCH configured to the relayed radio bearer, and upon expiry of the timer the remote WTRU may send the indication to the relay WTRU, for example. The duration of the timer may be set based on configuration information provided by the relay WTRU or network when configuring the LCH or radio bearer, for example. In another example, the duration of the timer may be determined by the remote WTRU based on a dynamic indication provided by the relay WTRU due to an increase/decrease in processing and/or load related latency at the relay WTRU.

Regarding the trigger condition of an indication from a relay WTRU, the relay WTRU may send an indication triggered by a change in the traffic load level and/or congestion conditions at the relay WTRU. The relay WTRU may send the information on load/congestion only for the LCHs which may have an assigned priority value that may be greater than or equal to the priority level assigned to the LCH associated with the remote WTRU, for example. In this case, the relay WTRU may indicate to the remote WTRU when the load/congestion for the LCHs increases above certain threshold, which may be a function of the E2E PDB associated with the data at the remote WTRU, for example.

Regarding the trigger condition of an indication from one or more higher layers (e.g., NAS), an indication may be triggered at the relay WTRU and sent to the remote WTRU based on a determination made at one or more higher layers at the relay WTRU, where the determination may be associated with a change in the latency. The higher layers in the relay WTRU (e.g., NAS layer, application layer, etc.), may monitor the end-to-end latency and trigger an indication to the remote WTRU in the event of an increase in the latency. Based on the indication from the relay WTRU, the remote WTRU may generate and send an indication to the relay WTRU for minimizing the latency associated with resource scheduling and/or triggering a relay WTRU assistance indication, for example.

Regarding the trigger condition associated with a value of, or change in, sidelink conditions/quality—In a scenario where the remote WTRU determines and includes the timing information related to latency in the sidelink, the remote WTRU may send an indication to relay WTRU based on monitoring and/or performing measurements of the sidelink channel conditions/quality (e.g., CBR and/or SL-RSRP measurements). A change in the sidelink channel measurements may be used to infer the expected latency associated with data (re)transmission on sidelink to relay WTRU. For example, if the sidelink channel conditions improve/deteriorate (e.g., CBR/SL-RSRP increases above a threshold or drops below a threshold) the remote WTRU may infer the change as an increase/decrease in latency on sidelink, and trigger a remote WTRU assistance indication to indicate the updated timing information to the relay WTRU. For example, the remote WTRU may be configured to transmit the indication when some quality measure (e.g., CBR) is above/below a threshold.

Regarding the trigger condition of a change in one or more factors, such as periodicity, offset, required grant size of a periodic transmission of data at the remote WTRU, or the like, then the remote WTRU may trigger the remote WTRU assistance indication. The trigger may be based upon the change in timing/offset of a periodic transmission to the relay WTRU, possibly by some (pre)configured amount, for example.

Regarding the trigger condition based on one or more criteria associated with the timing information/PDB of the data to be transmitted: For example, the remote WTRU may send the remote WTRU assistance indication if the transmission of a remaining PDB of a sidelink transmission is below a threshold, or if the sidelink transmission timing exceeds a configured first PDB (e.g., a threshold PDB for triggering the indication). Specifically, a WTRU may be configured with a first sidelink PDB and may preferably transmit the sidelink message within the first sidelink PDB. If transmission within the first sidelink PDB is not possible (e.g., due to limitations in resource selection and/or network scheduling), the WTRU may transmit the remote WTRU assistance indication message and transmit after the first PDB but within the second PDB. For example, the WTRU may transmit the indication if one or more of its selected transmission/retransmission resources do not meet a configured PDB.

Regarding the trigger condition based on reception of HARQ feedback, the remote WTRU may send an indication if it received HARQ NACK or DTX to one or more transmissions of a data packet.

In some situations, a remote WTRU operating in Mode 1 may trigger the transmission of a remote WTRU assistance indication. Specifically, a remote WTRU operating in Mode 1 may send a remote WTRU assistance indication to the relay WTRU after sending the SL-SR and/or SL-BSR to the network for requesting sidelink resources.

In one example, where the remote WTRU assistance indication may include the timing information related to the expected latency in the sidelink, the indication may be triggered after sending SL-SR and/or SL-BSR to the network and/or prior to receiving the sidelink resource grant. The relay WTRU may use the expected latency information in the indication to determine the timing information to be included in the relay WTRU assistance indication sent to the network, for example.

In another example, where the indication may not include the timing assistance information, the indication may be triggered after sending SL-SR and/or SL-BSR to the network and/or at a triggering time instance determined based on the awareness of different factors including the E2E PDB, the expected latency in the sidelink, and/or the processing latency at the relay WTRU. In this case, for ensuring that the relay WTRU does not trigger the remote WTRU assistance indication (e.g., SR, BSR) too early or too late, the timing for transmitting the remote WTRU assistance indication to relay WTRU may be aligned with the timing when the relay WTRU sends the relay WTRU assistance indication to the network, for example.

In an example, a remote WTRU may send the remote WTRU assistance information after sending the WTRU assistance information (e.g., UEAssistanceInformation) to the network to realign a sidelink configured grant, or after receiving a sidelink configured grant (re)configuration from the network. The remote WTRU may include the timing information associated with the WTRU assistance information or sidelink configured grant in the remote WTRU assistance information.

In some situations, a remote WTRU operating in Mode 2 may trigger the transmission of a remote WTRU assistance indication. Specifically, a remote WTRU operating in Mode 2 may initiate the resource (re)selection procedure for determining resources for sidelink data transmission before sending a remote WTRU assistance indication to the relay WTRU. The resource scheduling indication may be triggered when triggering conditions are satisfied (e.g., as described herein) and the sidelink resources for Mode 2 operation are available for sending the indication to the relay WTRU.

Since the remote WTRU may be aware of the E2E PDB requirement for the data, the remote WTRU may set the resource selection window size, comprising of T1 and T2 parameters based on the expected time for transmitting data in the sidelink. For example, for an E2E PDB of 40 ms, the remote WTRU may set T1 as 2 ms based on the processing delay in the remote WTRU after sending the indication to the relay WTRU and T2 as 5 ms as the maximum expected time for transmitting data to the relay WTRU in sidelink. The maximum expected time may comprise of one or multiple transmissions, and when multiple transmissions may be performed they may include retransmissions due to receiving HARQ feedback from the relay WTRU, for example. In this case, the maximum expected time T2 may be estimated as T0+n*(T1+T0), where n is the number of retransmissions (e.g., 0 or more) and T0 is the expected time duration per transmission, for example. Based on the resources selected, the remote WTRU may perform data transmission to the relay WTRU within a duration consisting of a minimum time of T1 and a maximum time of T2.

In the case where the remote WTRU provides the timing information to the relay WTRU in the remote WTRU assistance indication, the remote WTRU may indicate the maximum expected time (e.g., T2) as the timing information, for example.

In some situations, whether the relay WTRU performs transmission of BSR information may depend on information in the remote WTRU assistance indication. Specifically, a relay WTRU may determine whether or not to send buffer status information (e.g., possibly associated with one or more LCH or LCGs), trigger SR/BSR and/or trigger UEAssistanceInformation based on information in the remote WTRU assistance information. Such a situation may be motivated in that for a common gNB, the remote WTRU may have already indicated the buffer status associated with data to be relayed to the gNB, and the gNB may consequently schedule the relay WTRU as well. A relay WTRU, upon receiving the assistance indication, may determine not to send SR/BSR (e.g., or to omit certain buffer status(es) associated with relayed traffic in the BSR) to the network if the relay WTRU determines that the remote WTRU is in the coverage of the same gNB. The relay WTRU may send the SR/BSR otherwise. Alternatively, a relay WTRU may determine whether to send the SR/BSR based on an indication in the remote WTRU assistance indication, which may be provided to the remote WTRU by the gNB.

In one or more embodiments disclosed herein, there may be techniques for reducing latency applicable to relay WTRUs. In some situations, a relay WTRU may send one or more assistance indication(s) for performing transmission of relayed data. The relay WTRU may be triggered to send a transmission of a relay WTRU assistance indication to the network based on the remote WTRU assistance indication received from the remote WTRU. The relay WTRU assistance indication may be sent for aligning the resources in the sidelink and/or UL such that the data transmissions from the remote WTRU to the network via the relay WTRU may be performed considering the latency in the sidelink, UL, and/or the relay WTRU while satisfying the end-to-end QoS requirements (e.g., PDB). When UL resources (e.g., in UL-SCH) are available and can accommodate the indication (e.g., payload and header) from a relay WTRU, the relay WTRU assistance indication may be sent to the network using the available resources and after satisfying LCP related triggering conditions in the relay WTRU. Otherwise, the SR may be sent after triggering conditions are satisfied to request for UL resources for sending the relay WTRU assistance indication. Similarly, in a WTRU-to-WTRU relaying scenario, the relay WTRU may send the relay WTRU assistance indication for aligning the sidelink resources in the first hop (e.g., between the source WTRU and the relay WTRU) and the second hop (e.g., between the relay WTRU and the target WTRU) such that the data transmissions from the source WTRU to the target WTRU via the relay WTRU may be performed considering the latency in both sidelink hops and latency at the relay WTRU while satisfying the end-to-end QoS requirements (e.g., PDB).

The relay WTRU assistance indication may be sent in one or more of the following: UCI of either the PUCCH or PUSCH; control PDU (e.g., the indication may be sent as an RLC control PDU or as an adaptation layer control PDU); RRC (e.g., the indication may be sent as a WTRU assistance information in an RRC message); data payload (e.g., PUSCH); and/or, the UL MAC CE. For the UL MAC CE, the indication may be sent in a UL MAC CE that may include a bitmap corresponding to one or more information elements (e.g., expected data volume in one or more the LCHs associated with remote WTRU and configured with a DRB, timing information on when the data at relay WTRU may be available for UL transmission). Further, the one or more different information elements may be either sent in a single UL MAC CE or in different UL MAC CEs, and the one or more information elements within the indication, when sent in one or more MAC CEs, may be identified with new LCID(s) that are included in the UL MAC CE header.

There may be one or more triggering conditions for sending the relay WTRU assistance indication, such as a(n): indication from the remote WTRU; priority of associated LCH; LCH index; priority indicated by the remote WTRU; timing information in the remote WTRU assistance information (e.g., possibly associated with a required or remaining PDB); availability or expected availability of an UL grant at the relay WTRU (e.g., possibly meeting the latency requirement/PDB associated with the timing received in the remote WTRU assistance indication); and/or, a triggering time.

Regarding the triggering condition of an indication from the remote WTRU, the relay WTRU assistance indication may be triggered by the reception of the remote WTRU assistance indication from the remote WTRU and the availability of UL resources.

Regarding the triggering condition of a priority associated with one or more LCHs, the relay WTRU assistance indication may be triggered if: the LCG in a DRB of the relay WTRU, to which the egress LCH associated with the remote WTRU is mapped to, has no other associated LCHs with data or expected data from the relay WTRU or other remote WTRU(s); and/or, the priority value of the LCH associated with the remote WTRU is greater than or equal to the highest priority of other LCHs in the LCG containing data or with expected data for transmission.

In one example, the one or more LCHs associated with the DRB at the relay WTRU associated with data in the buffer may be handled differently than the LCHs with expected data. In this case, for the LCHs associated with expected data from one or more remote WTRUs, the triggering conditions for sending the relay WTRU assistance indication may be different than the triggering conditions applied for LCHs containing regular data in buffer. In another example, both the LCHs associated with expected data and the LCHs associated with regular data in buffer may use the same triggering conditions, such as based on the priority values associated with the LCHs.

Regarding the triggering condition of an LCH index, the relay WTRU may be (pre)configured to send relay WTRU assistance indication to the network only for certain LCHs.

Regarding the triggering condition of a priority indicated by the remote WTRU, the relay WTRU assistance indication may be triggered only for certain LCHs associated with the remote WTRU with a priority value above or equal to a configured threshold value. For other LCHs from the remote WTRU which are configured with a priority value below the configured threshold value, the regular BSR triggering conditions may apply. The priority value may be either indicated explicitly by the remote WTRU in the remote WTRU assistance indication or implicitly based on the LCH/LCG identifier used in the indication, which may be configured with a one-to-one mapping to a priority value known to the relay WTRU, for example.

Regarding the triggering condition of timing information in the remote WTRU assistance information, (e.g., which may be possibly associated with some required or remaining PDB), the relay WTRU may trigger the relay WTRU assistance indication for an LCH associated with the remote WTRU when satisfying criterion related to the end-to-end (E2E) PDB between the remote WTRU and the network (e.g., PDCP to PDCP). This criterion may be a sum of maximum expected latency due to relaying data from the remote WTRU to relay WTRU (L1) and/or the maximum expected latency at the relay WTRU due to processing (L2), wherein the sum is greater than or equal to a latency threshold T (e.g., L1+L2>=T).

The latency threshold may be determined as a function of the E2E PDB, time duration associated with resource scheduling (e.g., transmission of SR/BSR and reception of UL grant), and/or time duration due to a data transmission in UL. The latency threshold may be either configured in the relay WTRU (e.g., during a relayed path and radio bearer establishment) or may be determined by the relay WTRU based on the awareness of the E2E PDB and time duration due to a data transmission and UL scheduling. The relay WTRU may be configured with a threshold for each LCH or LCG associated with relaying. The relay WTRU may use an internal function/sublayer (e.g., adaptation layer) for tracking the latency between the remote WTRU and relay WTRU and between the relay WTRU and the network, for example. The expected latency may be determined from the indication related to timing information received in the remote WTRU assistance indication or based on tracking of the transmission time and number of retransmissions in sidelink from the remote WTRU, for example. In this case, if the latency in the sidelink is expected to increase from a previously determined value by a certain threshold, for example, due to the increase/decrease in sidelink conditions/quality (e.g., SL RSRP, CBR) and/or increase in the number of HARQ retransmissions, then the relay WTRU assistance indication may be triggered when satisfying the above criterion. Likewise, the change in the processing delay at the relay WTRU by a certain threshold as a result of switching between different TX/Rx modes including UL reception, UL transmission, sidelink transmission and/or sidelink reception, and/or change in the load at the relay WTRU by a certain threshold due to possible Tx/Rx from a number of remote WTRUs with higher priority, may result in satisfying the above criterion and triggering the transmission of the relay WTRU assistance indication. In the WTRU-to-WTRU relaying scenario, the processing delay at the relay WTRU may also include the expected transmission latency to the target WTRU due to sidelink conditions/congestion of the second hop (e.g., CBR, SL-RSRP, SL-CSI). In another example, when the above criterion is satisfied, the relay WTRU may change the priority value assigned to the LCH associated with the remote WTRU as well as one or more other LCHs associated with the LCG configured to the DRB to ensure that the relay WTRU assistance indication is not delayed. For example, for triggering the relay WTRU assistance indication the relay WTRU may increase the priority value assigned to the LCH associated with the remote WTRU, while possibly decreasing the priority value assigned to other LCHs, when the above criterion is met. In the case where the above criterion is not met, the relay WTRU may either: send an SR to the network for requesting resources using a selected SR configuration associated with the timing information based on a (pre)configured mapping between one or more SR configurations and different timing information; or, send an indication to the remote WTRU of the inability to meet the E2E PDB.

Regarding the triggering condition of an availability or expected availability of UL grant at the relay WTRU (e.g., possibly meeting the latency requirements/PDB associated with timing received in the remote WTRU assistance indication), the relay WTRU assistance indication may be sent based on the expected availability of UL grant for data in other LCHs whose priority may be lower than the priority assigned to the LCH associated with the remote WTRU. In this case, if the UL grant is expected to be available due to triggering of BSR for other LCHs and the data in other LCHs may be delayed without violating their respective PDB requirements, the relay WTRU may use the available UL grant for transmitting the data received from the relay WTRU. The relay WTRU assistance information may be sent only when the expected UL grant is unable to accommodate the data from the remote WTRU, for example. For example, the relay WTRU may trigger sending a relay WTRU assistance indication (e.g., SR) if it does not have an UL grant which meets certain timing requirements determined based on the timing information received in the remote WTRU assistance indication. For example, the relay WTRU may determine a required UL grant timing based on the timing or other information (e.g., remaining PDB, priority, etc.) in the remote WTRU assistance indication. If the relay WTRU determines that it does not have an UL grant which meets this timing, the relay WTRU may trigger the sending of the relay WTRU assistance indication to the network. The relay WTRU may further use delay-related information at the relay WTRU to determine whether the UL grant meets the timing requirements. For example, a relay WTRU may determine that an UL grant does not meet the timing requirements if the UL grant is too early with respect to reception of the data on sidelink, or too late with respect to the required latency of the data to be received on sidelink.

Regarding the triggering condition of a triggering time, upon receiving the remote WTRU assistance indication and determining the latest time for receiving the UL grant at the relay WTRU (e.g., based on tracking of sidelink latency and resource scheduling latency), the relay WTRU may trigger the sending of the transmission of the relay WTRU assistance indication at a time instance that enables satisfying the E2E PDB without having to include timing information in the relay WTRU assistance information, for example. In this case, the relay WTRU may set a timer when receiving the remote WTRU assistance indication, for a duration of a maximum allowable time for sending the remote WTRU assistance indication and receiving the UL grant within the E2E PDB limit. When the timer expires, the relay WTRU may reset the timer and send the transmission of the relay WTRU assistance indication to the network. In the case when the data from the remote WTRU may be available for transmission at the relay WTRU prior to the expiry of the timer for sending advanced BSR indication, the relay WTRU may cancel the timer and send a regular SR and/or BSR to request for UL grant.

The relay WTRU assistance indication may contain one or more of the following: expected data volume in LCH; and/or, relayed transmission timing information.

For the expected data volume in LCH, for example, the expected data volume may comprise the data volume that is available at an LCH configured to the relayed path in remote WTRU and/or indicated by the remote WTRU to the relay WTRU in the remote WTRU assistance indication.

For the relayed transmission timing information, for example, the timing information may be indicated in the form of a time slot index or a time offset value, which may be in reference to an initial/beginning time slot value (e.g., slot zero) for a frame comprising of a fixed number of time slots with each time slot spanning over a configured time duration. The reference initial time slot may be either the time when data arrives in a buffer at a remote WTRU or the time when the remote WTRU assistance indication is received at the relay WTRU, for example. Alternatively, the timing information may be indicated either as a time duration (e.g., 10 ms) or in the form of number of time slots, relative to an initial/beginning time slot value, for example. In another example, the timing information may be indicated implicitly by using LCH/LCG identifier and a configured mapping between the LCH/LCG identifier and the timing information. In this case, for sending the timing information in the remote WTRU assistance indication, the relay WTRU may select an LCH/LCH and the associated LCH/LCG identifiers from a configured set of LCH/LCG configurations which may be mapped to different time slot/duration values related to the timing information. As an example, the relay WTRU may be configured with a first LCG and a second LCG, which may be respectively mapped to a first time slot/duration value and a second time slot/duration value. Subsequently, to indicate the sum of latency in sidelink and latency at a relay WTRU which may correspond to the first time slot/duration, the relay WTRU may select the first LCG and its identifier when sending the relay WTRU assistance indication to the network. The relay WTRU may indicate to the network the one or more of the following timing information in the relay WTRU assistance indication: expected time for data to be received from the remote WTRU; expected time for the data to be ready for UL transmission at the relay WTRU; and/or, desired time slot for using UL grant.

For the expected time for data to be received from the remote WTRU, for example, the expected time may include the time duration for a first transmission and/or one or more retransmissions in the sidelink for transmissions expected from the remote WTRU.

For the expected time for the data to be ready for UL transmission at the relay WTRU, for example, the relay WTRU may indicate the earliest and/or latest time slot when the data may be transmitted in the UL. In this case, the earliest time slot may be determined as the sum of the maximum expected time duration due to sidelink transmission and expected time due to processing at the relay WTRU relative to the initial time slot. Likewise, the latest time slot may be determined by subtracting the maximum latency due to sidelink transmission and processing from the E2E latency relative to the initial time slot, for example.

For the desired time slot for using UL grant, for example, the relay WTRU may determine the desired time slot for using the UL grant based on the estimation of the time duration for receiving data in sidelink from the remote WTRU and time duration for processing at the relay WTRU. The time duration for receiving and processing may be either based on an average expected time or a maximum expected time determined from previous transmissions, for example.

The relay WTRU may indicate a desired time or time period implicitly using a time index. Such index may be explicitly included in the message (e.g., assistance indication), or may be implicitly indicated by the timing of the message transmission, the type of transmission, or the priority/LCG information. For example, the relay WTRU may select one of a number of SR configurations to indicate a desired time or time period. The desired time or time period may indicate one or more slots in which the UL grant should be provided. The desired time or time period may indicate the minimum or maximum time for reception of the UL grant. The desired time or time period may indicate an offset from a current grant (e.g., an UL configured grant) that the current grant should be changed or that a new grant should be issued.

There maybe one or more procedures for determining the timing information related to data at the relay WTRU. These procedures may involve the WTRU determining the timing information to be included in the relay WTRU assistance indication. This determination may take one or more of the following into consideration: expected latency on sidelink due to data transmission; explicit indication of the timing of resources in the remote WTRU assistance information; and/or, the processing latency at the relay WTRU.

Regarding the expected latency on sidelink due to data transmission, upon receiving the remote WTRU assistance indication the relay WTRU may determine data transmission latency in sidelink based on the expected number of transmissions, including retransmissions (e.g., HARQ), that may be performed by the remote WTRU for the data to be reliably received at the relay WTRU. The expected number of transmissions, in-turn, may be determined by the relay WTRU based on the sidelink channel conditions (e.g., CBR, CR, SL-RSRP) and/or radio bearer configuration related to a maximum number of HARQ retransmissions configured in the SL-RB between the remote and relay WTRU, for example. In another example, the relay WTRU may determine the expected latency based on the L1 link adaptation parameters (e.g., MCS) applied by the remote WTRU for sending the data. In this case, when the remote WTRU applies a higher MCS due to improved sidelink channel quality, the expected latency may be inferred to be lower and likewise expected latency may be inferred to be higher when the remote WTRU applies a lower MCS.

Regarding explicit indication of the timing of resources in the remote WTRU assistance information, the relay WTRU may receive an indication of the time/frequency resource associated with the first/last transmission of a sidelink transmission, and may derive the timing information to be included in the relay WTRU assistance indication based on this timing and other factors disclosed herein.

Regarding the processing latency at the relay WTRU, the processing latency at the relay WTRU may be determined by one or more of the following: the number of remote WTRUs served by the relay WTRU; CBR/CR; the amount of sidelink grants for reception intended at the relay WTRU (e.g., the number of SCI for periodic data for which the relay WTRU is expected to receive on sidelink, and therefore cannot transmit on UL); and/or, the amount of data to be relayed in the buffers of the relay WTRU (e.g., associated with a higher priority than indicated by the remote WTRU). For example, the processing latency may comprise of a first component due to handling of prioritized traffic and a second component due to switching between Uu/SL interfaces and half-duplex Tx/Rx modes. For example, the relay WTRU may determine the first component of processing latency based on the available data and expected data in buffers associated with one or more LCHs, such as from the relay WTRU and other remote WTRUs, whose priority may be different from the priority assigned to the LCH associated with the remote WTRU. The relay WTRU may determine the processing latency based on the expected time for receiving the UL grants and sending the data of other higher priority LCHs prior to sending the data from the remote WTRU, for example. In this case, the relay WTRU may either increase or decrease the priority of certain LCHs such that the E2E PDB of data in all LCHs corresponding to the relay WTRU and all associated remote WTRUs may be satisfied. The second component of processing latency may be determined as a function of the number the remote WTRUs served by the relay WTRU and/or the type of resources used by the remote WTRUs for sidelink data transmission (e.g., aperiodic, periodic), for example.

In some situations a WTRU may receive assistance configuration information for meeting E2E QoS when relaying data. Specifically, the relay WTRU may receive assistance configuration information from the network, including one or more rules and/or configuration parameters which may be applied by the relay WTRU for meeting E2E QoS when relaying data received from one or more remote WTRUs. The assistance configuration information, including rules and/or parameters, may be applicable at the granularity of per-remote WTRU, per-radio bearer (e.g., E2E radio bearer spanning from remote WTRU to gNB via relay WTRU) and one or more logical channels within a radio bearer, for example. In an example, the assistance configuration information received by a relay WTRU may indicate a first set of rules/parameters may be applicable when relaying data from/to a first remote WTRU and a second set of rules/parameters may be applicable when relaying data from/to a second remote WTRU.

The relay WTRU may receive the assistance configuration information, including rules/parameters, either via semi-static configuration or when receiving configuration associated with the one or more radio bearers/logical channels (e.g., on Uu link and/or PC5 link). In either case, the rules/parameters in the assistance configuration may be associated with certain identifiers (IDs) and possibly received via RRC message(s). Alternatively, the relay WTRU may receive the one or more rules/parameters dynamically via MAC CE or DCI, for example. In another alternative, the relay WTRU may receive assistance configuration information, comprising of one or more rules/parameters, as a pre-configuration via RRC message(s) followed by a dynamic activation/deactivation message which may be received via MAC CE or DCI, which may include the ID of a particular rule/parameter to be activated/deactivated for usage by the relay WTRU, for example. As described herein, a first link and a second link may be used to describe the links going to, and coming from, a relay WTRU, either of which may be a sidelink or a link to the network: the first link and second link as discussed herein may be interchangeable, and the examples provided discussing these links are not intended to be limiting but merely illustrative; further, either the first link or second link may be interchangeable with any specific type of link disclosed herein, such as Uu link, PC5 sidelink, or any other type of link. As an example, a first link may be a link between the network and the relay WTRU, and the second link may be a sidelink between the relay WTRU and the remote WTRU.

The relay WTRU may perform one or more actions, including sending the relay WTRU assistance indication to the network, for example, based on whether one or more of the rules and/or parameters indicated in the assistance configuration are satisfied. The assistance configuration parameters received by the relay WTRU and the corresponding actions performed based on satisfying/meeting one or more of the rules/parameters may include the following: rules/parameters related to data rate; rules/parameters related to latency; and/or, rules parameters related to reliability.

Regarding rules/parameters related to data rate, the relay WTRU may receive one or more rules and/or parameters for ensuring certain data rate may be achieved over a first link (e.g., Uu link) when relaying data received from one or more remote WTRUs. The rules/parameters that may be used by the relay WTRU for achieving a certain data rate when relaying and the corresponding actions performed may include one or more of the following: data rate matching; data rate compensation; and/or, data rate throttling.

Regarding data rate matching, the relay WTRU may be configured with one or more rules/conditions for relaying data such that the data rate that may be achieved when relaying the data over the first link (e.g., Uu link) matches the data rate achieved and/or expected to be achieved over the second link (e.g., PC5 sidelink), for example. In an example, the relay WTRU may receive one or more data rate range parameter values indicating the upper and/or lower bound for data rate over the second link (e.g., sidelink). In this case, on the condition that the data rate over the second link is within the received data rate range parameter values (e.g., within upper and/or lower bounds), the relay WTRU may perform certain actions to ensure that the data rate that may be achieved over the first link matches or is within a similar data rate range when transmitting the data to the network (e.g., base station, gNB, etc.). On detecting the condition where the data rate over the second link is within the data rate range parameters (e.g., based on remote WTRU indication or measurement/detection of data rate over sidelink), the action(s) performed by the relay WTRU may include sending a relay WTRU assistance information indication to the network, and/or indicating that the condition is met or using a particular logical channel configuration for matching the data rate when relaying the data received from the remote WTRU over the first link, for example. On detecting that the condition associated with the data rate over the second link is not met, where the sidelink data rate is outside of the configured data rate range, for example, the relay WTRU may send an indication to the network, indicating that the condition is not met.

Regarding data rate compensation, the relay WTRU may be configured with one or more rules when relaying, such that the data rate that may be achieved when relaying data over a first link (e.g., Uu link) is higher than the data rate achieved and/or expected to be achieved over the a second link (e.g., PC5 sidelink) for ensuring data rate compensation, for example. In an example, the relay WTRU may receive one or more data rate threshold values indicating the lower bound data rate values achieved or expected to be achieved over the second link. The relay WTRU may also receive, for the different lower bound data rate values over the second link, the corresponding mapping to an expected data rate value to be achieved over the first link. On the condition that the data rate over the second link is below and/or equal to a lower bound data rate value, the relay WTRU may perform certain actions such that the data rate achieved over the first link link is at least above the lower bound data rate over the second link and/or increases by a certain value up to the expected data rate value when transmitting over the first link, for example. On detecting the condition associated with the data rate over the second link (e.g., based on remote WTRU indication or measurement/detection of data rate over sidelink), the action(s) that may be performed by the relay WTRU may include sending a relay WTRU assistance indication to the network, indicating the triggering of data rate compensation for increasing the data rate up to the expected data rate value when relaying the data received from remote WTRU over the first link, for example. On detecting the condition associated with data rate over sidelink is not met, where the sidelink data rate is above the configured lower bound data rate, for example, the relay WTRU may send an indication to network, indicating that the condition is not met.

Regarding data rate throttling, the relay WTRU may be configured with one or more rules when relaying such that the data rate that may be achieved when relaying data over a first link (e.g., Uu link) is lower than the data rate achieved and/or expected to be achieved over the second link (e.g., PC5 sidelink) for supporting the data rate throttling/reduction, for example. In an example, the relay WTRU may receive one or more data rate threshold values indicating the higher bound data rate values achieved or expected to be achieved over the second link. The relay WTRU may also receive, for the different higher bound data rate values over the second link, the corresponding mapping to an expected data rate value to be achieved over the first link. On the condition that the data rate over the second link is above and/or equal to a higher bound data rate value, the relay WTRU may perform certain actions such that the data rate achieved over the first link is below the higher bound data rate over the second link and/or decreases by a certain value up to the expected data rate value when transmitting over the first link, for example. On detecting the condition associated with the data rate over the second link (e.g., based on remote WTRU indication or measurement/detection of data rate over sidelink), the action(s) that may be performed by the relay WTRU may include sending a relay WTRU assistance indication to the network, indicating the triggering of data rate throttling for decreasing the data rate up to the expected data rate value when relaying the data received from remote WTRU over the first link, for example. On detecting the condition associated with data rate over the second link is not met, where the second link data rate is below the configured higher bound data rate, for example, the relay WTRU may send an indication to network, indicating that the condition is not met.

Regarding rules/parameters related to latency, for example, the relay WTRU may receive one or more rules and/or parameters for ensuring certain latency may be achieved over the first link (e.g., Uu link) when relaying data received from one or more remote WTRUs. The rules/parameters that may be used by the relay WTRU for achieving certain latency when relaying and the corresponding actions performed may include one or more of the following: latency compensation, and/or latency threshold T for meeting E2E latency.

Regarding latency compensation, the relay WTRU may be configured with one or more rules when relaying such that the latency that may be achieved when relaying data over the first link (e.g., Uu link) is lower than the latency achieved and/or expected to be achieved over the second link (e.g., PC5 sidelink) for meeting E2E latency requirement(s), for example. In an example, the relay WTRU may receive one or more sidelink latency threshold values indicating the latency over the second link. The relay WTRU may also receive, for the different latency threshold values over the second link, the corresponding mapping to an expected latency value to be achieved over the first link. On the condition that the latency over the second link is above and/or equal to the latency threshold value, the relay WTRU may perform certain actions such that the latency achieved over the first link decreases by a certain value up to the expected latency value when transmitting over the first link, for example. On detecting the condition where the latency over the second link is met (e.g., based on remote WTRU indication or measurement/detection of latency over sidelink), the action(s) that may be performed by the relay WTRU may include sending a relay WTRU assistance indication to the network, indicating the triggering of latency compensation for decreasing the latency up to the expected latency value when relaying the data received from remote WTRU over the first link, for example. Alternatively, another action that may be performed by the relay WTRU may include determining/selecting a logical channel configuration over the first link, which may be configured with one or more parameters related to priority, prioritized bit rate (PBR), bucket size duration (BSD), etc., such that the latency that may be achieved over the first link may be decreased up to the expected latency value, for example. On detecting the condition associated with latency over the second link is not met, where the latency over the second link is below the latency threshold value, for example, the relay WTRU may send an indication to the network, indicating that the condition is not met or the relay WTRU may not send any indication and continue using the existing configuration when relaying.

Regarding latency threshold T for meeting E2E latency, for example, the relay WTRU may receive a latency threshold T for assisting with determining whether and/or when to send the relay WTRU assistance information to the network. In this case, the relay WTRU may send to the network the relay WTRU assistance indication when the estimated latency for relaying, determined as a function one or more component latency values, is greater than or equal to the latency threshold T, for example. For example, the component latency values used by the relay WTRU for determining the estimated latency for relaying may include one or more of the following: expected latency due to relaying data from the remote WTRU to the relay WTRU; expected latency at the relay WTRU due to processing (e.g., sending data in buffer); expected time due to resource scheduling (e.g. transmission of SR/BSR/assistance info and reception/activation of UL grant/configured grant); expected latency due to transmission of data in UL. In this case, on the condition associated where the latency threshold T is met, where the estimated latency for relaying (e.g. sum of latency components) is greater than or equal to the latency threshold T, the relay WTRU may send to the network a relay WTRU assistance indication, for example.

Regarding rules/parameters related to reliability, for example, the relay WTRU may receive one or more rules and/or parameters for ensuring certain reliability may be achieved over a first link (e.g., the Uu link) when relaying data received from one or more remote WTRUs. The rules/parameters that may be used by the relay WTRU for achieving certain reliability when relaying and the corresponding actions performed may include reliability matching.

Regarding reliability matching, the relay WTRU may be configured with one or more rules/parameters for relaying data such that the reliability of a data transmission that may be achieved when relaying over a first link matches the reliability achieved and/or excepted to be achieved over a second link (e.g., a Uu link matches the reliability achieved and/or expected to be achieved over a PC5 sidelink). In an example, the relay WTRU may receive one or more reliability range parameter values (e.g., packet error rate, bit error rate, etc.) indicating the upper and/or lower bounds of reliability achieved or expected to be achieved over the sidelink. In this case, on the condition that the reliability over the second link is within the received reliability range parameters (e.g., within upper and/or lower bounds), the relay WTRU may perform certain actions to ensure that the reliability that may be achieved over the first link matches or is within a similar reliability range when transmitting the data over the second link. On detecting the condition where the reliability over the second link is within the reliability range parameters (e.g., based on remote WTRU indication or measurement/detection of reliability over sidelink), the action(s) performed by the relay WTRU may include sending a relay WTRU assistance information indication to the network, where the relay WTRU assistance information may indicate that the condition is met using one or more logical channel configurations, or using one or more lower layer configurations (e.g., MCS configuration, number of HARQ retransmissions) for matching the reliability when relaying the data received from the remote WTRU over the first link, for example. On detecting the condition associated with reliability over the second link is not met, the relay WTRU may send an indication to the network indicating that the condition is not met.

In some situations, the relay WTRU may change the prioritization of the relayed data for meeting E2E PDB. Specifically, a relay WTRU may compensate for the latency in the sidelink due to data transmission from the remote WTRU by dynamically changing the LCH configuration (e.g., priority) in one or more LCHs/DRBs configured at the relay WTRU such that the E2E PDB of data associated with the remote WTRU may be satisfied.

A relay WTRU may be configured with one or more LCHs per DRB, where each LCH may be configured with different parameters, such as priority, prioritized bit rate (PBR), and/or bucket size duration (BSD) to achieve a certain QoS profile (e.g., E2E PDB) when relaying data associated with the remote WTRU. LCH configuration may further include mapping of the LCH to UL LCG for the purposes of BSR reporting. LCH configuration may further indicate the routing of a SL LCH to an UL LCH.

For enabling dynamic adaptation of LCH configuration for the LCHs associated with remote WTRU, the relay WTRU may be pre-configured with multiple allowed configuration parameters per LCH. The different configurations associated with a LCH may be identified with a configuration identifier/index value along with the LCH ID. Among different configurations, one of the configurations may be designated as the primary/default configuration for an LCH and the other one or more configurations may be designated as secondary configurations of the LCH. For example, the parameters of the first configuration for a LCH may include a priority level that may be lower/higher than the priority level assigned to a second configuration for the LCH. The priority level may, in turn, correspond to a different latency achievable, for a given amount of traffic load (e.g., data in LCH buffers), when transmitting data in UL. As an example, for a first LCH configured with a priority level p1 that results in a latency of t1 ms and for a second LCH configured with a priority level p2 that results in a latency of t2 ms, the relative latency may result in t2<t1 when p2>p1.

The relay WTRU may be initially configured to activate the first configuration for an LCH associated with the remote WTRU. The relay WTRU may also be configured with the rules to activate the second LCH configuration when detecting the latency related triggers. The first LCH configuration with priority p1 may be activated by the network during initial configuration of the end-to-end radio bearer (e.g., between remote WTRU-to-NW), for example. The relay WTRU may then activate a second LCH configuration with priority p2, where p2>p1, when satisfying the following criteria: E2E Latency when using p1 for a LCH associated with the remote WTRU exceeds E2E PDB; and/or, E2E Latency when using p2 for a LCH associated with the remote WTRU is less than or equal to E2E PDB.

In a scenario where an UL grant is available due to a previous transmission of BSR, the relay WTRU may apply/activate a different LCH configuration and priority level for the LCHs associated with the relay WTRU or other remote WTRUs when it may be possible to use the available UL grant for the remote WTRU (e.g., E2E PDB1) and deprioritize the UL transmission without impacting their respective E2E PDBs (e.g., E2E PDB2), for example. In this case, in addition to the above criteria, the relay WTRU may activate a second LCH configuration with priority p2 for the remote WTRU while activating LCH configuration with priority p4 (e.g., from previous priority level p3, where p3>p4), when satisfying the following: E2E Latency when using p3 for a LCH associated with the relay WTRU and/or other remote WTRUs is less than or equal to E2E PDB2.

For ensuring both the network and the relay WTRU apply the same configuration for an LCH, the relay WTRU may indicate to the network when the LCH configuration is changed at the relay WTRU. For example, when a second configuration is activated for an LCH, possibly after deactivating an initial first configuration, the relay WTRU may indicate the index associated with the second configuration to the network. The relay WTRU may indicate the change in the LCH configuration in the remote WTRU assistance information, as an example.

In some situations, the relay WTRU in operating in Mode 1 may receive DL data intended for the remote WTRU and sidelink resource scheduling information. A relay WTRU operating in SL Mode 1 may receive downlink data intended for a remote WTRU from a network and relay the data to the remote WTRU in an associated sidelink transmission scheduled by the same network node (e.g., gNB). To perform such a relay transmission, a relay WTRU may receive one or more of the following: downlink relay data intended for a remote WTRU in a NR PSSCH and associated PSCCH transmission; and/or, sidelink resource scheduling information for the associated sidelink transmission in a NR PSCCH transmission. A relay WTRU may receive this listed data and information in: two sequential DL transmissions with DL DCI in one transmission and SL DCI in the other; and/or, one DL transmission with a DL DCI including both DL and sidelink scheduling information.

In one case where the relay WTRU receives information in two sequential DL transmissions with DL DCI in one transmission and SL DCI in the other, the relay WTRU may decode a downlink control information (DCI) format in a NR PDCCH (e.g., DCI 1_1 or DCI 1_0) in a (pre)configured NR PDCCH search space/CORESET for downlink data scheduling information using its assigned C-RNTI or CS-RNTI. Based on the decoded DCI, the relay WTRU may decode the associated NR PDSCH, that may include the downlink relay data.

The relay WTRU may determine that the received downlink data may be relayed to a remote WTRU based on a higher layer configuration, such as a LCH identification and/or sidelink destination ID information. The relay WTRU may store the received downlink relay data in a SL HARQ buffer for sidelink transmission to a remote WTRU. Subsequently, the relay WTRU may decode a DCI in a NR PDCCH, such as a DCI 3_0 in a (pre)configured NR PDCCH search space/CORESET for sidelink scheduling information using SL-RNTI or SL-CS-RNTI. The network may transmit such sidelink scheduling information to the relay WTRU without receiving a SR/BSR for sidelink grant request, as the network may be aware that the relay WTRU may require a sidelink grant to relay the received downlink relay data. The relay WTRU may associate the received DL data intended for a remote WTRU with the sidelink grant and transmit the received DL data to the remote WTRU in a PSSCH transmission based on the sidelink scheduling information included in the received DCI 3_0 transmission.

In one case where the relay WTRU receives information in one DL transmission with a DL DCI including both DL and sidelink scheduling information, the relay WTRU may be (pre)configured with a relay DCI that has a format that may include both downlink scheduling information of a NR PDSCH transmission carrying the downlink relay data and sidelink scheduling information of a subsequent SL PSSCH transmission to a remote WTRU. A relay DCI format, such as DCI 1_X (where x is just a placeholder for any number), may include information from DCI 1_1/DCI 1_0 and/or DCI 3_0. For example, DCI 1_1/DCI_1_0 may be used for scheduling of PDSCH in one cell and DCI 3_0 may be used for scheduling of NR sidelink in one cell. In one example, zero padding may be included in DCI 1_1/DCI 1_0 to ensure an equal size between all DCI formats. The zero padding may be reduced to minimize the DCI format size by introducing a (pre)configured association between DL and sidelink resources. The association may include one or more of the following: an association between the indicated DL carrier and/or BWP and sidelink resource pool; an association between the indicated DL frequency resource and sidelink frequency resource; an association between the indicated DL HARQ process number (HPN) and SL HPN; and/or, an association between indicated DL downlink assignment index (DAI) and SL sidelink assignment index (SAI).

Regarding the association between the indicated DL carrier and/or BWP and sidelink resource pool, a WTRU may determine a sidelink resource pool for sidelink relay transmission based on the DL carrier and/or BWP included in the DCI 1_X without an additional DCI indication for the sidelink resource pool.

Regarding the association between indicated DL frequency resource (e.g., starting PRB block of DL PSSCH) and sidelink frequency resource (e.g., index of the lowest sidelink sub-channel), a WTRU may determine the starting sidelink sub-channel index based on the decoded starting PSSCH PRB without an additional DCI indication for starting sidelink sub-channel index, for example.

Regarding the association between the indicated DL HPN and SL HPN, a WTRU may determine a SL HPN based on the DL HPN indicated in the DCI 1_X without an additional DCI indication for SL HPN.

Regarding the association between the indicated DL DAI and SL SAI, a WTRU may determine a SL SAI based on the DL DAI and the DCI format (e.g., DL DAI in the relay DCI format may count also as a SL DAI).

Generally, a DCI format identifier may be used to differentiate between the DCI formats. Also, a relay WTRU may be (pre)configured with an identifier (e.g., a C-relay-RNTI and/or SL-relay-CS-RNTI) to descramble a relay-specific DCI 1_X format. A relay WTRU may decode the relay downlink DCI format in a NR PDCCH in a (pre)configured NR PDCCH search space/CORESET using an identifier (e.g., C-RNTI, C-CS-RNTI or C-relay-RNTI). In one example, the candidate DCI format associated with one or multipole such (pre)configured search space/CORESET may include sidelink relay data. In another example, such candidate DCI formats may include DCI formats for both DL and sidelink relay data, (e.g., a relay WTRU may differentiate a DCI format for sidelink relay data scheduling based on a DCI format identifier and/or descrambled RNTI). Based on the decoded DL data scheduling information included in the relay DCI (e.g., DCI 1_X format) a relay WTRU may decode an associated NR PDSCH, that may include the downlink relay data and store the received downlink data in a sidelink HARQ buffer for sidelink relay transmission. A relay WTRU may accordingly transmit the received relay downlink data on sidelink based on the sidelink scheduling information included in the same relay DCI transmission. In some cases, the approach with one DL transmission including both a DL DCI including both DL and sidelink scheduling information may thus reduce the latency caused by processing, such as the processing of a WTRU requesting and receiving a sidelink resource for relay transmission.

In some situations, the relay WTRU may determine whether to transmit buffer status to the network based on DL LCH and/or reception of a DL DCI. A WTRU may exclude reporting of sidelink buffer status to the network and/or avoid triggering of BSR upon reception of data in a SL LCH when the data is associated with a relayed LCH from the network. Specifically, a WTRU may report only sidelink buffer status associated with SL LCHs that are not relayed or mapped to DL LCHs to be relayed on sidelink. Alternatively, a WTRU may compute the amount of data on a SL LCH that is associated to relayed data, and subtract the buffer status associated with that SL LCH or LCG that corresponds to buffered data from the total amount of data before reporting the buffer status associated with a SL LCH or LCG. Alternatively, a WTRU may trigger SL BSR only if the data arriving at a SL LCH is not associated with data being relayed from a DL LCH.

A WTRU may further have the aforementioned behavior associated with buffer status reporting of SL LCHs based on an indication from the network (e.g., in the DL DCI in which the relayed data was received). For example, a WTRU may exclude buffer status associated with SL LCHs if the DL DCI contains an indication to that effect, and the WTRU receives data on a DL LCH to be relayed on sidelink.

In some situations, a relay WTRU operating in Mode 2 may trigger resource selection based on an initialization indication received in the DL. A relay WTRU operating in Mode 2 may determine the resource (re)selection window size and/or triggers sensing and/or resource (re)selection in advance for relaying DL data to a remote WTRU based on a resource reselection initialization indication received from the network. Since the relay WTRU operating in Mode 2 determines the sidelink resources autonomously, triggering a resource reselection in advance may enable the relay WTRU to minimize the latency associated with determining the resources and transmitting data in sidelink to the remote WTRU and to meet the E2E PDB requirement in DL.

The relay WTRU may receive the resource reselection initialization (RRI) indication from the network (e.g., containing one or more of the information elements described herein) in one or more of the following: DCI in the PDCCH (e.g., the DCI may further contain a priority indication or timing information, from which the WTRU can derive the parameters for the resource selection); DL MAC CE (e.g., the DL MAC CE containing the RRI indication may be sent using a new/dedicated LCID in the header); RRC signaling (e.g., the RRC message containing the RRI indication may be sent as either a configuration message or a single-shot control transmission message); and/or, DL Control PDU (e.g., the RRI indication may be sent as an RLC control PDU).

There may be one or more triggering conditions for initiating resource (re)selection at a relay WTRU. The relay WTRU may perform resource (re)selection for determining the sidelink resources upon receiving the RRI indication and/or on condition a resource selection criterion is satisfied. As an example, the resource selection criterion may trigger resource selection when one or more of the following conditions are met: the relay WTRU has no available resources; and/or, the relay WTRU has available resources but such resources are unable to accommodate the expected data, or the required latency associated with the data.

For example, in a case where the resources or required latency cannot be accommodated, the priority of expected data (e.g., indicated in RRI indication) may be greater than the priority of available resources, or the priority is associated with a latency which is smaller than the latency associated with the available resources. Alternatively, in the same case where the resources or required latency cannot be accommodated, there may be a mismatch between the size and/or the transmission timing (e.g., time slots, periodicity) associated with the expected data with that of the size and/or timing of the available resources. Based on sidelink resources determined using the information received in the RRI indication, the relay WTRU may then relay the data PDU received in DL to the remote WTRU.

For the content of a resource reselection initialization (RRI) indication receive by a relay WTRU, the RRI indication may be received by the relay WTRU each time when there is a data PDU to be relayed to the remote WTRU or as a single shot triggering message that initiates the transmission of multiple data PDUs (e.g., periodic data). The RRI indication may contain one or more of the following information elements: data volume of the data intended for the remote WTRU; priority of DL data for relaying; PDB related information; timing information for resource (re)selection; and/or, timing information for aligning periodic resources.

For the data volume of the data intended for the remote WTRU, the relay WTRU may be indicated with the volume of the expected data in one or more LCHs associated with relayed radio bearers that connect the remote WTRU and network via the relay WTRU. For each LCH with data in buffer the relay WTRU may be indicated with the data volume (e.g., bit size) and/or an identifier (e.g., the identifier (ID) of the LCH, ID of LCG, and/or ID of the radio bearer). For a relay WTRU associated with multiple remote WTRUs, the RRI indication may also indicate the availability of data for one or more remote WTRUs by including the identifiers of the remote WTRUs (e.g., RNTI) in the same RRI indication.

For the priority of DL data for relaying, the relay WTRU may be indicated with the priority associated with the LCHs that have data in buffer for DL transmission via the relay WTRU. The priority may be either indicated explicitly in the RRI indication or implicitly by indicating the identifier/ID of the LCH or ID of the LCG associated with the LCH. The relay WTRU may then identify the priority based on a mapping between the ID of LCH/LCG and priority configured at the relay WTRU, for example. In another example, the priority indicated in the RRI indication may be associated with the resource (re)selection window size related to the T2 value (e.g., end-time in window size). In this case, the relay WTRU may determine the resource (re)selection window T2 value based on the priority value in RRI indication and possibly, a configured mapping between the priority and the T2 value, for example.

For the PDB related information, the relay WTRU may be indicated with the expected remaining time available for the relay WTRU to perform resource scheduling and data transmission in sidelink to the remote WTRU. The expected remaining time for performing resource scheduling and transmission in sidelink may be determined by subtracting the expected delay due to (re)transmission on DL from the E2E PDB, for example.

For the timing information for resource (re)selection, the relay WTRU may be indicated with a first timing information and/or a second timing information related to the resource (re)selection window size, where the first timing information may be related to T2 (e.g., end-time in window size) and the second timing information may be related to T1 (e.g., start-time in window size). The relay WTRU may then determine the resource (re)selection window based on the T2 and/or T1 timing information received in the RRI indication. The timing information may also contain the start time for triggering sensing/measuring/monitoring for determining resources autonomously and/or initiating resource (re)selection, for example. In another example, the timing information related to the resource (re)selection window size may be indicated as a single value comprising of the size of the window (e.g., T2-T1); the relay WTRU may then perform resource (re)selection using this single value.

For timing information for aligning periodic resources, in the case where the relay WTRU is expected to receive periodic data transmission from the network and relay the data to a remote WTRU in sidelink with the aligned timing attributes (e.g., apply the same periodicity in sidelink), the relay WTRU may determine the offset value and periodicity to apply along with the resource (re)selection window size when performing resource (re)selection for periodic resources in sidelink. In this case, the relay WTRU may determine the offset value for initiating the periodic transmission in sidelink based on the processing and/or switching time for transitioning from DL reception to sidelink transmission. The relay WTRU may use the same periodicity indicated in the RRI indication when performing resource (re)selection for ensuring that the data reception in DL and data transmission in sidelink are aligned.

In one example embodiment, a WTRU (e.g., relay WTRU) may determine and indicate to the network timing information for using an uplink (UL) grant based on an indication received from a remote WTRU and at least one of: expected latency in sidelink, expected latency at relay WTRU, and/or end-to-end packet delay bound (E2E PDB) related criterion.

A WTRU (e.g., relay WTRU) may perform one or more steps in such an embodiment. The WTRU may receive a remote WTRU assistance indication in SCI from the remote WTRU. The contents of the remote WTRU assistance indication may include data volume in LCH buffer at the remote WTRU, expected latency to be incurred in sidelink, and/or priority information. The WTRU may determine timing information as a function of expected transmission latency on SL (L1) and expected processing latency in relay WTRU (L2) (e.g., information in the SCI). For example, the timing information may be determined as L1+L2.

The WTRU may trigger a relay WTRU assistance indication, upon reception of the remote WTRU assistance indication in SCI, when a E2E PDB related criterion is met. The contents of the relay WTRU assistance indication may include expected data volume in LCH buffer associated with the remote WTRU and the determined timing information (e.g., desired time slot for receiving UL grant). The E2E PDB related criterion may indicate: Trigger relay WTRU assistance indication when the determined timing information is less than or equal to a configured latency threshold T (e.g., L1+L2<=T). The WTRU may select a logical channel group (LCG) for sensing the relay WTRU assistance indication based on priority (e.g., in the SCI) and the determined timing information (e.g., using a configured mapping between LCG and timing information). If the criterion is not met, the relay WTRU may either: send SR to network using a selected SR configuration associated with timing; or Indicate to the remote WTRU the inability to meet E2E PDB.

The WTRU may relay in UL, the PDU received from remote WTRU, using the received UL grant.

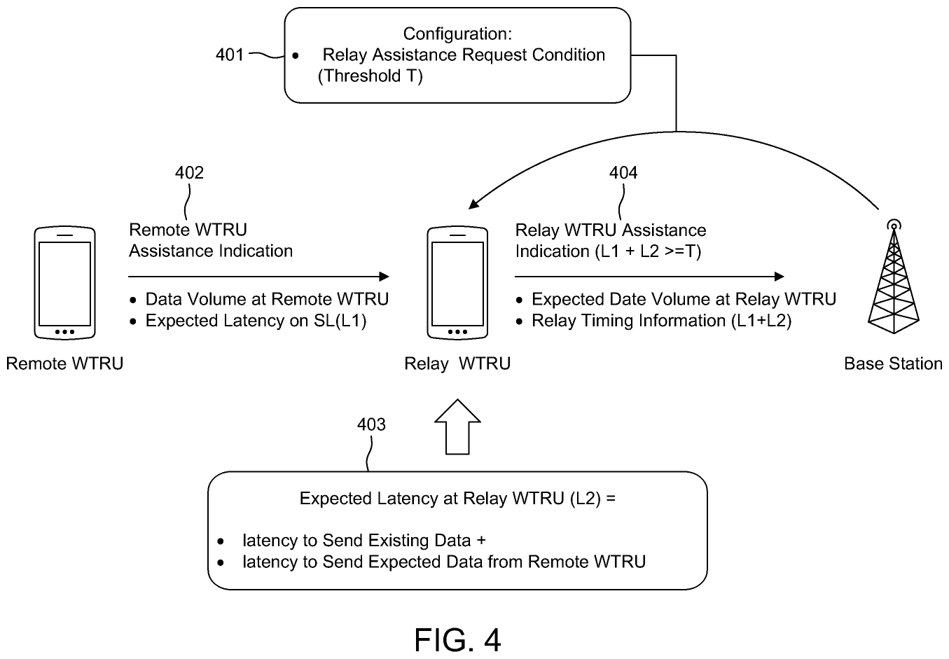

FIG. 4 is a diagram of an example process for acquiring a relay grant based on a determined latency. There may be a relay scenario where a remote WTRU is connection with a relay WTRU which is in connection with the network (e.g., base station, etc.). The relay WTRU may relay data from the remote WTRU to the network. In order to do this, it may need to acquire UL resources from the network. At 401, the network may send a configuration to the relay WTRU. The configuration information may include a relay assistance request condition, which may be some threshold (T). At 402, the remote WTRU may send a remote assistance indication. The remote assistance indication may include data volume information (e.g., data volume at the remote WTRU that will need to be relayed) and the expected latency on the sidelink (L1) between the remote WTRU and the relay WTRU. At 403, the relay WTRU may determine an expected latency time at the relay WTRU (L2) based on any latency related to data at the relay WTRU that needs to be sent (e.g., in a buffer, processing or relaying data coming from another remote WTRU or the network, etc.) and any latency related to the data volume information sent from the remote WTRU (e.g., the relay WTRU may determine this latency based on the data volume information sent from the remote WTRU). At 404, The relay WTRU may determine whether the expected latency on sidelink (L1) and any latency at the relay WTRU (L2) add up to a sum that meets and/or exceeds the threshold (T) that was received from the network; then the relay WTRU may send an assistance indication to the network requesting a grant of UL resources. After this request is sent, the network may send an UL grant of resources, and the relay WTRU may use these resources to relay data from the remote WTRU to the network, the Each of the aforementioned steps, taken in part or in whole, may be optional and may occur in any order.

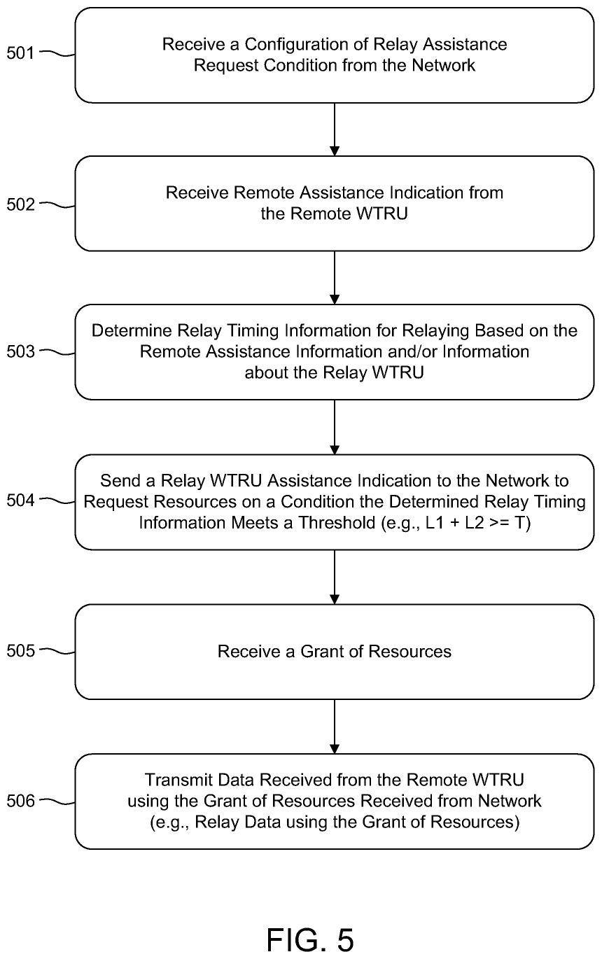

FIG. 5 is a flow chart of an example process for acquiring a relay grant based on a determined latency. At 501, the relay WTRU may receive a configuration of relay assistance request condition from the network. At 502, the relay WTRU may receive a remote assistance indication from the remote WTRU. At 503, the relay WTRU may determine relay timing information for relaying based on the remote assistance information and/or the information about the relay WTRU. At 504, the relay WTRU may send a relay assistance indication to the network requesting resources on a condition that the determined relay timing meets a threshold from the configuration. At 505, the relay WTRU may receive a grant of resources (e.g., from the network). At 506, the relay WTRU may relay data using the grant of resources. Each of the aforementioned steps, taken in part or in whole, may be optional and may occur in any order.

In one example embodiment, a WTRU (e.g., relay WTRU) sets resources reselection window (e.g., T2) and triggers resource reselection in advance for relaying downlink (DL) data to remote WTRU based on an indication received from network

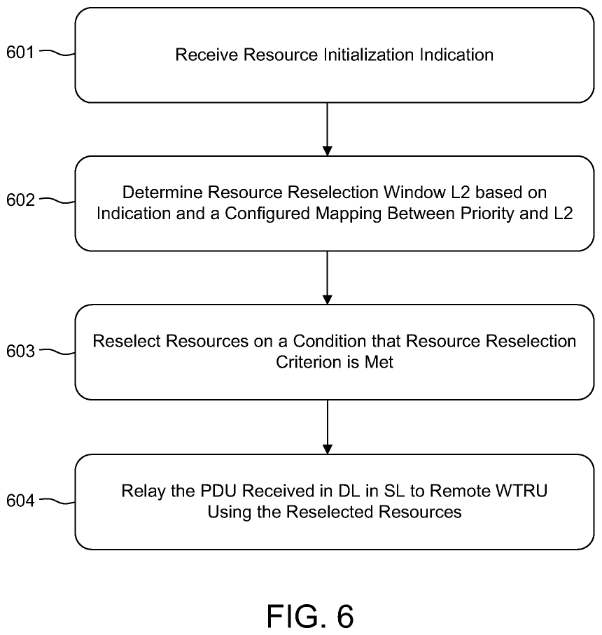

FIG. 6 is a flow chart of an example process for managing resources for relaying data. A WTRU (e.g., relay WTRU) may perform one or more steps in such an embodiment. At 601, The WTRU may receive a resource selection initialization indication. The contents of the resource selection initialization indication may include expected data volume for data intended for the remote WTRU and priority information. For example, such a resource selection initialization indication may be received in DCI. At 602, the WTRU may determine resources reselection window T2 based on the indicated priority and a configured mapping between priority and T2. At 603, the WTRU may trigger resource reselection when a resource selection criterion is met. A resource selection criterion may trigger resource reselection on a condition that: no resources are currently available; or, available resources are unable to accommodate the expected data due to the priority of expected data being greater than the priority of available resources and/or a mismatch between expected data size/timing and available resource size/timing. At 604, the WTRU may relay in sidelink to the remote WTRU the PDU received in DL using the determined resources. Each of the aforementioned steps, taken in part or in whole, may be optional and may occur in any order.

In one example embodiment, a relay wireless transmit receive unit (WTRU) may receive sidelink control information (SCI) from a remote WTRU. The SCI may include a relay WTRU assistance indication, and the relay WTRU assistance indication may include expected latency information. The WTRU may determine timing information based on the expected latency information. The WTRU may be triggered to send a remote WTRU assistance indication based on the relay WTRU assistance information, and then relay a PDU of the remote WTRU using a received uplink grant from the SCI.

According to one or more embodiments disclosed herein, a remote WTRU may send assistance indication on data for relaying with PDB requirement to relay WTRU in sidelink, which may concern one or more of the following: the contents of the remote WTRU assistance indication; methods for sending remote WTRU assistance indication; methods to determine resources for sending the remote WTRU assistance indication; and/or, triggering conditions for sending remote WTRU assistance indication to relay WTRU.

According to one or more embodiments disclosed herein, a remote WTRU operating in Mode 1 may trigger the transmission of remote WTRU assistance indication.

According to one or more embodiments disclosed herein, a remote WTRU operating in Mode 2 may trigger the transmission of remote WTRU assistance indication.

According to one or more embodiments disclosed herein, a relay WTRU may send assistance indication for performing transmission of relayed data, which may concern one or more of the following: triggering conditions for generating and transmitting the relay WTRU assistance indication; contents of relay WTRU assistance indication included by relay WTRU; and/or, methods for determining timing information related to relayed data at relay WTRU.

According to one or more embodiments disclosed herein, a relay WTRU may change the prioritization of relayed data for meeting E2E PDB.

According to one or more embodiments disclosed herein, a relay WTRU operating in Mode 1 may receive DL data intended for remote WTRU and sidelink resource scheduling information, such as: two sequential DL transmissions with DL DCI in one transmission and SL DCI in the other; and/or, one DL transmission with a DL DCI including both DL and SL scheduling information

According to one or more embodiments disclosed herein, a relay WTRU operating in Mode 2 may trigger resource reselection based on initialization indication received in DL, which may concern one or more of the following: triggering conditions for initiating resource (re)selection at relay WTRU; and/or, contents of resource reselection initialization indication received by relay WTRU.

Any embodiment or example described herein is not intended to be read in isolation of the rest of the description. Any embodiment described herein may be read in view of other techniques disclosed in other sections of the description. Any embodiment described herein may comprise of steps, where any step, taken in part or in whole, may be optional and may be performed in any order.

As described herein, a higher layer may refer to one or more layers in a protocol stack, or a specific sublayer within the protocol stack. The protocol stack may comprise of one or more layers in a WTRU or a network node (e.g., eNB, gNB, server, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a relay wireless transmit receive unit (WTRU), the method comprising:
receiving configuration information from a base station, wherein the configuration information includes a relay assistance threshold;
receiving remote WTRU assistance information via a sidelink from a remote WTRU;
sending an assistance indication to the base station on a condition that a total time is greater than the relay assistance threshold, wherein the total time is determined from the remote WTRU assistance information;
receiving resource information indicating a grant of resources from the base station; and
relaying data by receiving the data from the remote WTRU via the sidelink and sending the data to the base station using the grant of resources.

2. The method of claim 7, wherein the remote WTRU assistance information includes an expected latency time of the sidelink and data volume information, wherein the total time comprises a first time plus a second time, wherein the first time is determined from the expected latency time of the sidelink, and wherein the second time is determined from the data volume information.

3. The method of claim 1, wherein the grant of resources includes one or more time slots.

4. The method of claim 1, wherein the configuration information is control information received in a control channel transmission.

5. The method of claim 1, wherein the remote WTRU assistance information is received in sidelink control information or a sidelink medium access control (MAC) control element.

6. The method of claim 1, wherein the resource information indicating the grant of resources is received in response to sending the assistance indication.

7. A relay wireless transmit/receive unit (WTRU), the WTRU comprising:
a processor connected to a transceiver,
the processor and transceiver configured to receive configuration information from a base station, wherein the configuration information includes a relay assistance threshold;
the processor and transceiver configured to receive remote WTRU assistance information via a sidelink from a remote WTRU;
the processor and transceiver configured to send an assistance indication to the base station on a condition that a total time is greater than the relay assistance threshold, wherein the total time is determined from the remote WTRU assistance information;
the processor and transceiver configured to receive resource information indicating a grant of resources from the base station; and
the processor and transceiver configured to relay data by receiving the data from the remote WTRU and sending the data to the base station using the grant of resources.

8. The WTRU of claim 7, wherein the remote WTRU assistance information includes an expected latency time of the sidelink and data volume information, wherein the total time comprises a first time plus a second time, wherein the first time is determined from the expected latency time of the sidelink, and wherein the second time is determined from the data volume information.

9. The relay WTRU of claim 7, wherein the grant of resources includes one or more time slots.

10. The relay WTRU of claim 7, wherein the configuration information is control information received in a control channel transmission.

11. The relay WTRU of claim 7, wherein the remote WTRU assistance information is received in sidelink control information or a sidelink medium access control (MAC) control element.

12. The relay WTRU of claim 7, wherein the resource information indicating the grant of resources is received in response to sending the assistance indication.

13. The relay WTRU of claim 8, wherein the second time is further determined from an amount of data in a buffer of the relay WTRU.

14. The method of claim 2, wherein the second time is further determined from an amount of data in a buffer of the relay WTRU.
